(19) United States
(12) Patent Application Publication
(10) Pub. No.: US 2026/0143240 A1
(43) Pub. Date: May 21, 2026

(54) PHOTOELECTRIC CONVERSION SYSTEM, PHOTOELECTRIC CONVERSION APPARATUS, AND EQUIPMENT

(71) Applicant: CANON KABUSHIKI KAISHA, Tokyo (JP)

(72) Inventor: TOSHIYUKI FUKUI, Kanagawa (JP)

(21) Appl. No.: 19/386,525

(22) Filed: Nov. 12, 2025

(30) Foreign Application Priority Data
Nov. 20, 2024 (JP) 2024-202616

(51) Int. Cl. H04N 23/73; H04N 23/745; H04N 23/84

(52) U.S. Cl. CPC H04N 23/73; H04N 23/745; H04N 23/84

(57) ABSTRACT

A photoelectric conversion system comprising a photoelectric conversion apparatus that includes an image sensor arranged with a plurality of pixel blocks in which a plurality of pixels are arranged in a matrix, and a memory unit. In one frame period, the photoelectric conversion apparatus performs a first image capturing operation that includes an exposure period based on a first exposure condition set in advance, and a second image capturing operation for which an exposure period is controlled based on a second exposure condition decided for each pixel block. The memory unit stores a first image signal having a data amount smaller than a data amount of an image signal acquired by the photoelectric conversion apparatus by the first image capturing operation.

### BACKGROUND

### Field of the Technology

One disclosed aspect of the embodiments relates to a photoelectric conversion system, a photoelectric conversion apparatus, and an equipment.

### Description of the Related Art

In order to widen the dynamic range of an image capturing apparatus, a method has been proposed in which the exposure condition of an imaging sensor is changed for each region. Japanese Patent Laid-Open No. 2021-129144 discloses that the entire light receiving region of an imaging sensor is divided into a plurality of regions and the exposure period is set for each region.

### SUMMARY

According to one aspect of the disclosure, there is provided a photoelectric conversion system. The photoelectric conversion system comprises a photoelectric conversion apparatus that includes an image sensor arranged with a plurality of pixel blocks in which a plurality of pixels are arranged in a matrix, and a memory unit, wherein in one frame period, the photoelectric conversion apparatus performs a first image capturing operation that includes an exposure period based on a first exposure condition set in advance, and a second image capturing operation for which an exposure period is controlled based on a second exposure condition decided for each pixel block, and the memory unit stores a first image signal having a data amount smaller than a data amount of an image signal acquired by the photoelectric conversion apparatus by the first image capturing operation.

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram showing an example of the schematic configuration of an image capturing apparatus and its connection with an external controller;

FIG. 2 is a view for explaining an image sensor unit;

FIG. 3 is a block diagram showing an example of the configuration of an exposure correction unit;

FIG. 4 is a view showing the relationship between control of the exposure period and the light emission cycle of an LED light source in the image capturing target;

FIG. 5 is a view for explaining the configuration of an exposure image and the state of the exposure image stored in a line buffer;

FIG. 6 is a table for explaining the relationship among the exposure condition in region specific exposure control, the exposure period, and the analog gain;

FIG. 7 is a block diagram showing an example of the configuration of an exposure correction unit;

FIG. 8 is a flowchart illustrating the processing procedure;

FIG. 9 is a flowchart illustrating the processing procedure;

FIG. 10 is a view for explaining the configuration of an exposure image and the state of the exposure image stored in a line buffer;

FIG. 11 is a block diagram showing an example of the configuration of an exposure correction unit;

FIG. 12 is a block diagram showing an example of the configuration of an exposure correction unit;

FIG. 13 is a view for explaining the configuration of an exposure image and the state of the exposure image stored in a line buffer;

FIG. 14 is a block diagram showing an example of the configuration of an exposure correction unit;

FIG. 15 is a view for explaining the state of image information stored in a line buffer;

FIG. 16 is a flowchart illustrating the processing procedure;

FIG. 17 is a flowchart illustrating the processing procedure; and

FIG. 18 is a view showing an example of application of the apparatus according to an embodiment to equipment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

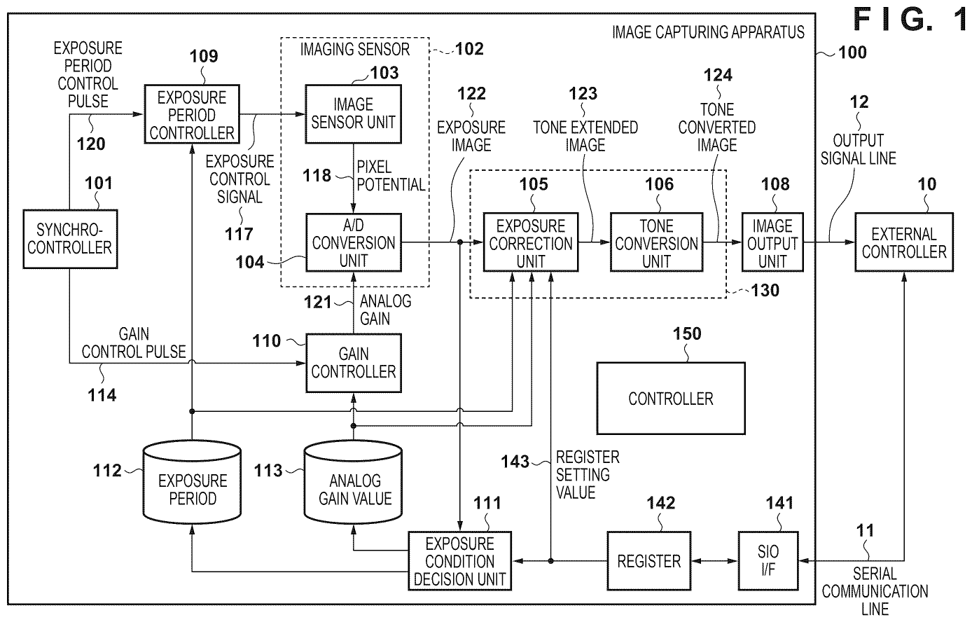

FIG. 1 is a block diagram showing an example of the schematic configuration of an image capturing apparatus 100 according to this embodiment to which an image processing apparatus is applied, and its connection with an external controller. Although the image capturing apparatus 100 according to this embodiment also includes various kinds of components of a general image capturing apparatus, for the sake of illustrative and descriptive simplicity, FIG. 1 shows only main constituent parts according to this embodiment. With reference to FIGS. 1 to 3, an image capturing operation will be described, which is performed while setting an exposure condition for each region including a pixel block (to be referred to as “region specific exposure control” hereinafter). Note that the constituent parts described below are merely examples. The functions of multiple constituent parts described later may be combined into one or may be separated. Alternatively, one constituent part may also perform the function of another constituent part.

The image capturing apparatus 100 according to this embodiment includes a synchronization controller 101, an image sensor unit 103, an analog/digital (A/D) conversion unit 104, an exposure correction unit 105, a tone conversion unit 106, an image output unit 108, an exposure period controller 109, a gain controller 110, and an exposure condition decision unit 111. In order to reflect the setting applied from an external controller 10, the image capturing apparatus 100 also includes a serial interface (SIO I/F) 141 and a register 142 for storing a setting value. The image capturing apparatus 100 is connected to the external controller 10 using a serial communication line 11 and an output signal line 12.

An imaging sensor 102 according to this embodiment can include the image sensor unit 103 where pixels including photoelectric conversion elements are arranged, and the A/D conversion unit 104 that performs analog-digital (A/D) conversion of a photoelectric conversion signal from a pixel portion. In the pixel portion, a plurality of pixels are arranged across a plurality of rows and a plurality of columns. Each of the plurality of pixels includes a photoelectric conversion element. Each of the plurality of pixels can also include a pixel output circuit that outputs the signal of the photoelectric conversion element, as needed. All or part of the image sensor unit 103 including the photoelectric conversion elements can be called a photoelectric conversion apparatus. Alternatively, all or part of the imaging sensor 102 including the A/D conversion unit 104 and other processing circuits can be called a photoelectric conversion apparatus. All or part of the image capturing apparatus 100 can be called a photoelectric conversion system. In the following description, the imaging sensor is taken as an example of the photoelectric conversion apparatus and described, but the present disclosure is not limited to this example. For example, the content of the present disclosure is also applicable to a sensor that performs at least one of distance measurement and light measurement.

Each of the synchronization controller 101, the exposure period controller 109, the gain controller 110, and the exposure condition decision unit 111 can be an image capturing control apparatus that controls image capturing. The image capturing control apparatus can include at least one of the synchronization controller 101, the exposure period controller 109, the gain controller 110, and the exposure condition decision unit 111. Each of the exposure correction unit 105 and the tone conversion unit 106 can function as an image processing apparatus that performs image processing on an exposure image 122 or a signal generation unit 130 that generates signals. The image processing apparatus can include at least one of the exposure correction unit 105 and the tone conversion unit 106.

The image capturing apparatus 100 can also include a controller 150 that controls the image capturing apparatus 100. The controller 150 may be included in each unit of the image capturing apparatus 100, such as the synchronization controller 101, the exposure correction unit 105, the tone conversion unit 106, the exposure period controller 109, the gain controller 110, and the exposure condition decision unit 111. The controller 150 can control the respective units of the image capturing apparatus 100, such as the synchronization controller 101, the exposure period controller 109, the gain controller 110, the exposure correction unit 105, and the tone conversion unit 106. The controller 150 can control part or all of the image capturing apparatus 100.

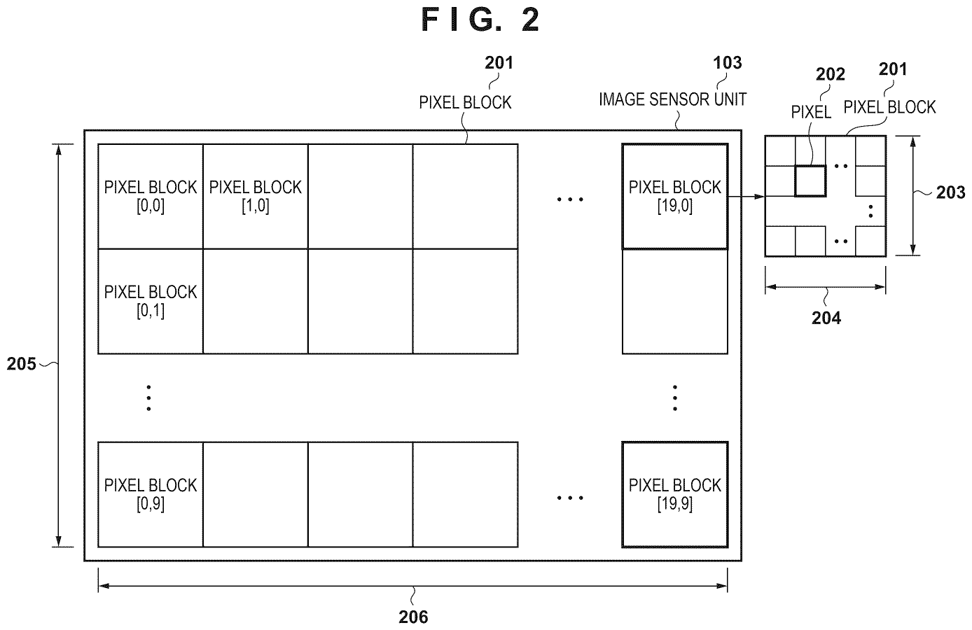

The outline of the image capturing apparatus 100 will be described. The image sensor unit 103 includes an imaging region (light receiving region) for image capturing. A plurality of light receiving elements are arranged in the imaging region so as to correspond to the pixels. The light receiving element can be the photoelectric conversion element. The imaging region is further divided into a plurality of regions as shown in FIG. 2, which are referred to as pixel blocks 201 that include the plurality of pixels. In other words, a plurality of pixel blocks 201 can be arranged in the image sensor unit 103. Multiple pixels 202 can be arranged in a matrix in each pixel block 201.

In the image sensor unit 103, the image capturing operation can be driven on a pixel block (to be also referred to as “region” hereinafter) basis. For the image sensor unit 103, an exposure condition can be decided for each region, and an exposure operation can be performed according to an exposure period different for each region. The exposure period corresponds to a charge accumulation period during which the photoelectric conversion element included in the pixel can accumulate charges. Note that the pixel block (region) will be described later with reference to FIG. 2. Here, a description will be given assuming that the photoelectric conversion element is configured to accumulate charges using a p-n junction where a p-type semiconductor region and an n-type semiconductor region are joined. However, the photoelectric conversion element is not limited to this form. For example, the photoelectric conversion element may be an avalanche photodiode (APD). Each pixel may be a pixel that operates as a single photon avalanche diode (SPAD). In this case, the pixel includes an APD, a quench element connected to the output node of the APD, and a waveform shaping circuit connected to the output node and configured to shape an output from the APD into a pulse waveform. The pixel further includes a counter that counts pulse signals output from the waveform shaping circuit. In this case, the exposure period to be described below can be a period from the start to the end of a count operation of the counter.

In this embodiment, for the image sensor unit 103, the exposure period can be set for each region in accordance with an exposure control signal 117 supplied from the exposure period controller 109. Exposure can be performed using the exposure period set for each region. The exposure control signal 117 is a signal for setting a region specific exposure period with respect to each region of the image sensor unit 103. The image sensor unit 103 performs exposure using the exposure period set for each region in accordance with the exposure control signal 117, reads out the charges accumulated in each pixel as a pixel potential 118 from each pixel, and outputs it to the A/D conversion unit 104.

The A/D conversion unit 104 AD-converts the pixel potential 118 read out from the image sensor unit 103 into a digital value. For the A/D conversion unit 104, the gain controller 110 can set an analog gain 121 corresponding to each region. The A/D conversion unit 104 amplifies the signal of the pixel potential 118 output from the image sensor unit 103 by the analog gain 121 set for each region, and then AD-converts the signal into a digital signal.

The image signal, which is the digital signal obtained by being amplified by the analog gain 121 set for each region and then AD-converted by the A/D conversion unit 104, is called the exposure image 122. The exposure image 122 output from the A/D conversion unit 104 is transmitted to the exposure condition decision unit 111 and the exposure correction unit 105.

Based on the input exposure image 122, the exposure condition decision unit 111 can decide an exposure period 112 and an analog gain value 113 to set an appropriate condition for image capturing for each region, and update the exposure period 112 and the analog gain value 113. The exposure condition decision unit 111 can decide an exposure condition including the exposure period 112 and the analog gain value 113. As an example of updating, the exposure condition decision unit 111 acquires the histogram of signal level values (pixel values) of the pixels for each pixel block based on the luminance distribution of the exposure image 122. If the histogram of pixel values in the pixel block (region) has pixel values distributed on the bright side, the exposure condition decision unit 111 changes and updates the exposure period 112 and the analog gain value 113 corresponding to this pixel block to setting values for darker image capturing. The next image capturing can be performed based on the updated values.

If the histogram has pixel values distributed on the dark side, the exposure condition decision unit 111 can change and update the exposure period 112 and the analog gain value 113 corresponding to this pixel block to setting values for brighter image capturing. The value of the exposure period 112 for each region is transmitted to the exposure period controller 109 and the exposure correction unit 105. The analog gain value 113 for each region is transmitted to the gain controller 110 and the exposure correction unit 105.

The synchronization controller 101 generates an exposure period control pulse 120 and a gain control pulse 114. The synchronization controller 101 outputs the exposure period control pulse 120 to the exposure period controller 109, and outputs the gain control pulse 114 to the gain controller 110. Thus, the synchronization controller 101 can perform timing synchronization control between the processing of the exposure period controller 109 and the processing of the gain controller 110.

The exposure period control pulse 120 is a signal for controlling the timing at which the exposure period controller 109 outputs the exposure control signal 117 to the image sensor unit 103. The exposure period controller 109 outputs the exposure control signal 117 to the image sensor unit 103 based on the exposure period control pulse 120, thereby setting the exposure period for each arbitrary pixel block of the image sensor unit 103.

The gain control pulse 114 is a signal for controlling the timing at which the gain controller 110 outputs the analog gain 121 to the A/D conversion unit 104. The gain controller 110 outputs the analog gain 121 to the A/D conversion unit 104 based on the gain control pulse 114, thereby setting the gain to be applied to the pixel potential for each arbitrary pixel block. In this manner, in this embodiment, the synchronization controller 101 synchronizes and controls operations of the exposure period controller 109 and the gain controller 110. By applying, at the timing matched with the exposure period, the analog gain to the pixel potentials from the respective pixels for each pixel block of the image sensor unit 103, the exposure image 122 can be output from the imaging sensor 102.

Based on the exposure period control pulse 120 and the value of the exposure period 112 for each region, the exposure period controller 109 generates the exposure control signal 117 for each region, and outputs it to the image sensor unit 103. With this, the exposure period corresponding to the exposure period 112 for each region is set in the image sensor unit 103 at the appropriate timing.

In accordance with the timing of the gain control pulse 114, the gain controller 110 outputs, to the A/D conversion unit 104, the analog gain value 113 for each region as the analog gain 121 for each region corresponding to the pixel potentials 118 for each region of the image sensor unit 103. With this, in the A/D conversion unit 104, the pixel potentials 118 for each region are amplified by the analog gain 121 corresponding to each region and then AD-converted. The AD-converted data is transmitted as the exposure image 122 for each region to the exposure correction unit 105 and the exposure condition decision unit 111 under the control of the controller 150.

For the exposure image 122 for each region transmitted from the A/D conversion unit 104, the exposure correction unit 105 accumulates the exposure images 122 captured in the same frame while changing the exposure condition, performs necessary processing, and then executes adding processing for each pixel. This processing will be described later. On the image having undergone the adding processing, the exposure correction unit 105 further performs tone expansion processing based on the exposure period 112 and the analog gain value 113, thereby generating a tone extended image 123.

From the exposure image 122 for each region represented by, for example, 10 bits, the exposure correction unit 105 can generate the tone extended image 123 represented by 23 bits. The detailed operation of the exposure correction unit 105 will be described later. The generated tone extended image 123 is transmitted to the tone conversion unit 106.

The tone conversion unit 106 performs tone conversion on the tone extended image 123, and outputs atone converted image 124 to the image output unit 108. In this embodiment, tone conversion is processing of converting, for example, the 23-bit tone extended image 123 into, for example, a 12-bit signal by gamma conversion, thereby generating the tone converted image 124. Note that the tone conversion processing in this embodiment is performed to suppress the data rate in the subsequent processing. In this embodiment, the exposure image 122 and the tone converted image 124 have a 10-bit length and a 12-bit length, respectively. However, these bit lengths are merely examples, and not limited thereto.

The image output unit 108 outputs the tone converted image 124 to the subsequent component of the image capturing apparatus 100 or to the outside. In this embodiment, the external controller 10 is connected as a processing module for receiving the image signal from the image capturing apparatus 100. Here, the output signal line 12 connecting the image output unit 108 and the external controller 10 may be an LVDS signal line having 16 data channels. However, the kind and data channel width of the signal line are not limited by this embodiment, and can be selected in accordance with the data transmission amount and data transmission speed.

The external controller 10 is also connected to the serial I/O (SIO) I/F 141 of the image capturing apparatus 100 via the serial communication line 11. The SIO I/F 141 is connected to the register 142, and the external controller 10 can set necessary information in the register 142 in the image capturing apparatus 100 via the SIO I/F 141. The information set in the register 142 is transmitted to the exposure condition decision unit 111. The exposure condition decision unit 111 can decide the exposure condition by using the information set in the register 142 in advance.

An example of the configuration of the image sensor unit 103 will be described with reference to FIG. 2. The imaging region of the image sensor unit 103 includes a plurality of regions shown as the pixel blocks 201. Furthermore, the multiple pixels 202 can be arranged in a matrix in the pixel block 201. In this embodiment, 2,000 pixels are arranged in the widthwise direction (the horizontal line direction indicated by reference numeral 206) of the imaging region of the image sensor unit 103, and 1,000 pixels are arranged in the height direction (indicated by reference numeral 205) (that is, 1,000 horizontal lines are provided in the vertical direction). In addition, 100 pixels are arranged in the widthwise direction (the horizontal line direction indicated by reference numeral 204) of the pixel block 201, and 100 pixels are arranged in the height direction (indicated by reference numeral 203) (that is, corresponding to 100 horizontal lines in the vertical direction). In this case, in the imaging region of the image sensor unit 103, 20 pixel blocks 201 are arranged in the horizontal direction, and 10 pixel blocks 201 are arranged in the vertical direction. These numbers of pixels and lines are merely examples for the descriptive convenience, and not limited thereto.

The notations “pixel block [0, 0] to pixel block [19, 9]” written in the respective pixel blocks 201 shown in FIG. 2 indicate the positions of the respective pixel blocks 201 in the imaging region. The values in brackets [ ] represent the horizontal and vertical indices of each pixel block in the imaging region. In FIG. 2, for example, the pixel block 201 located at the upper right of the image sensor unit 103 is represented as the pixel block [19, 0].

A set of pixel blocks represented by the same vertical index is referred to as a block row. For example, a block row N is constituted by pixel blocks [0, N] to [19, N]. In the example shown in FIG. 2, N=0 to 9. For example, the block row 5 is constituted by pixel blocks [0, 5] to [19, 5]. Note that the size (the numbers of pixels in the vertical and horizontal directions) of each of the image sensor unit 103 and the pixel block 201 are not limited to the examples described above. The shapes and aspect ratio of the pixel 202 are also not limited. The shape of the pixel block may be not a square but, for example, a rectangle. Furthermore, the pixel block 201 may be constituted by only one pixel 202. In this embodiment, the exposure period and the analog gain can be controlled on the pixel block 201 basis.

Here, the exposure period corresponds to the charge accumulation period during which charges are accumulated in the pixel (light receiving element) of the image sensor unit 103 during image capturing. Accordingly, for example, if the quantity of incident light on the image sensor unit 103 is the same and the pixels are not saturated, the longer the exposure period, the higher the pixel potential 118, and a brighter image can be captured. That is, if the quantity of incident light is the same and pixel saturation is not taken into consideration, for example, when comparing an exposure period of ( 1/480) sec with an exposure period of ( 1/30) sec, a brighter image can be captured with the exposure period of ( 1/30) sec.

The analog gain is a gain value applied to the pixel potential 118 in the A/D conversion unit 104 during image capturing. Accordingly, the larger the analog gain value, the larger the digitalized pixel value to be output from the A/D conversion unit 104, that is, the larger the digital value amplified by the analog gain and then AD-converted.

Referring back to FIG. 1, the configuration and operation of the image capturing apparatus 100 according to this embodiment will be described. The image sensor unit 103 performs image capturing while the exposure period is controlled for each region, that is, on the pixel block 201 basis, based on the exposure control signal 117. Then, the image sensor unit 103 outputs the pixel potentials 118 corresponding to the charges accumulated for each pixel.

The A/D conversion unit 104 applies the analog gain 121 set for each pixel block of the image sensor unit 103 to the pixel potentials 118 output from the image sensor unit 103, performs digital conversion, and outputs the exposure image 122. Note that in this embodiment, for the sake of descriptive convenience, the exposure image 122 is assumed to be a 10-bit digital value. The analog gain 121 can take four gain values of, for example, ×1, ×2, ×4, and ×8.

The exposure correction unit 105 performs tone expansion processing based on the exposure period 112 and the analog gain value 113, which are set for each region, on the exposure image 122 input from the A/D conversion unit 104, and outputs the tone extended image 123. The exposure correction unit 105 recognizes the image capturing condition of the exposure image 122 for each region from the exposure period 112 for each region and the analog gain value 113 for each region. Then, the exposure correction unit 105 corrects the exposure image 122 for each region based on the image capturing condition of the exposure image 122 for each region.

The exposure correction unit 105 performs tone expansion processing based on the exposure period 112 and the analog gain value 113 applied to image capturing on the exposure image 122 for each region transmitted from the A/D conversion unit 104, thereby generating the tone extended image 123. For example, the exposure correction unit 105 recognizes the image capturing condition of the input exposure image 122 for each region from the exposure period 112 for each region and the analog gain value 113 for each region, and corrects the exposure image 122 for each region in accordance with the condition.

The exposure correction unit 105 performs tone expansion processing on the exposure image 122 for each region represented by, for example, 10 bits, thereby generating the tone extended image 123 represented by 23 bits. Then, the generated tone extended image 123 is transmitted to the tone conversion unit 106.

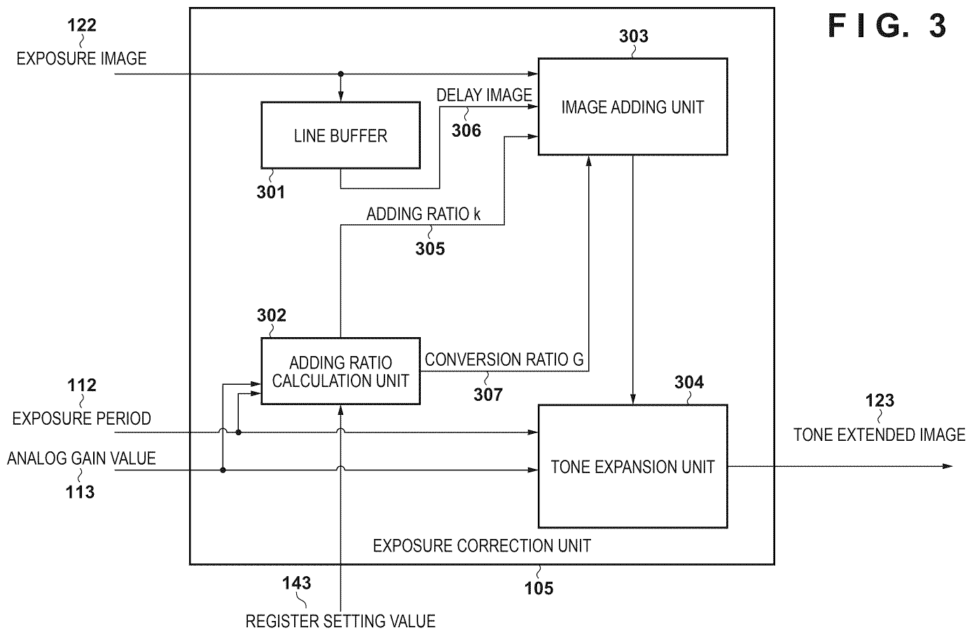

Next, the operation of the exposure correction unit 105 will be described. FIG. 3 is a block diagram showing an example of the configuration of the exposure correction unit 105. The exposure correction unit 105 includes a line buffer 301 as a memory unit, an adding ratio calculation unit 302, an image adding unit 303, and a tone expansion unit 304.

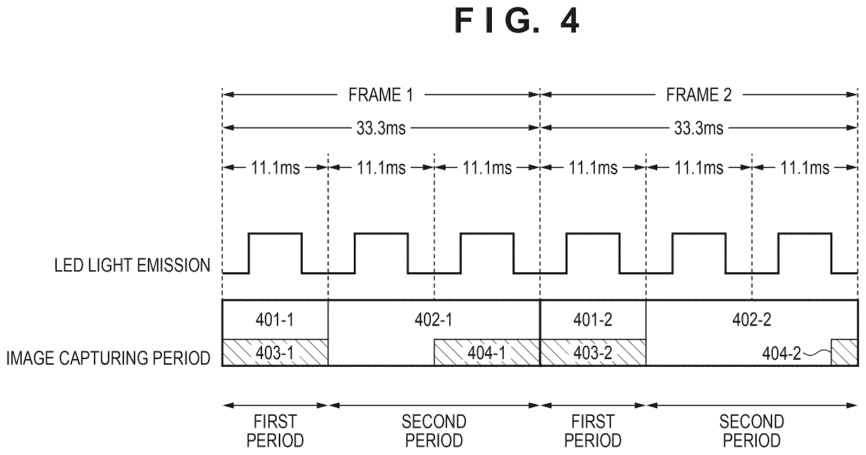

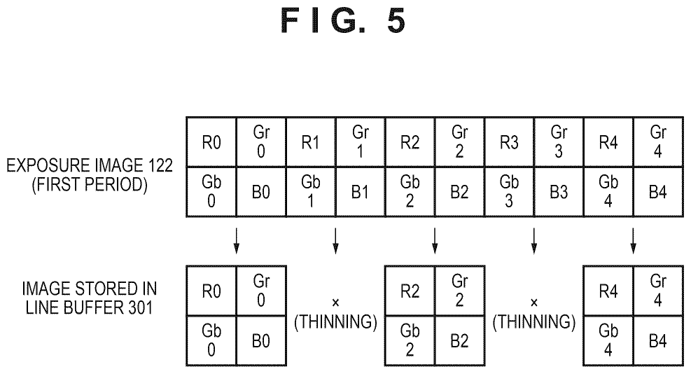

The operation of each component of the exposure correction unit according to this embodiment will be described with reference to FIGS. 4 and 5. In this embodiment, a description is given assuming that the image output frame rate is 30 frame/sec when the image capturing apparatus 100 captures a moving image. At this frame rate, a length λ of one frame (one frame period) is 1/30 sec (33.3333 ms (rounded to the fourth decimal place; the same applies below)). A frame can also be defined as the period from the time when a synchronization signal for controlling a scanning circuit that scans multiple pixels on a row basis or on a column basis is set active to the time when the synchronization signal is set active again. When the synchronization signal is set active, the scanning circuit can start scanning of multiple pixels on a row basis or on a column basis.

Regarding the source of flicker, for example, it is assumed that the maximum light emission frequency of an LED light source included in the image capturing target is 90 Hz, and that light is emitted at a constant cycle with a duty of 50%. In this case, a light emission cycle T of the light source that can cause flicker is a maximum of 1/90 sec (11.1111 ms). In FIG. 4, for the sake of descriptive convenience, the cycles of 1/30 sec and 1/90 sec are written as 33.3 ms and 11.1 ms, respectively.

In FIG. 4, two frames of a frame 1 and a frame 2 will be taken as an example and described. In this embodiment, the image capturing periods of frames 1 and 2 are divided into first periods 401-1 and 401-2 in the first half of each frame, and second periods 402-1 and 402-2 in the second half of each frame following the first period, respectively, and the respective periods are defined as shown in FIG. 4. Note that when describing the first period of any one of the frame 1 and the frame 2, it will be written as the “first period 401,” and when describing the second period of any one of the frame 1 and the frame 2, it will be written as the “second period 402.”

In the example shown in FIG. 4, one frame period includes the first period 401 and the second period 402. The first period 401 has a length of the first period that is a predetermined period set to be equal to or longer than the light emission cycle of the LED. In this embodiment, the predetermined period has the same length as the light emission cycle T of the LED, which is 1/90 sec (about 11.1111 ms). A period 403 is the first exposure period of the image sensor in the first period. In the first period 401, the exposure period of the image sensor is always set across the whole first period.

In FIG. 4, the first exposure periods in the first periods 401 of the two frames are represented as first exposure periods 403-1 and 403-2, and the second exposure periods in the second periods 402 thereof are represented as second exposure periods 404-1 and 404-2. Note that when describing the first exposure period of any one of the frame 1 and the frame 2, it will be written as the first exposure period 403, and when describing the second exposure period of any one of the frame 1 and the frame 2, it will be written as a second exposure period 404.

As shown in FIG. 4, since the first period 401 is set to be equal to or longer than the light emission cycle of the LED, it can include the period during which the LED is emitting light (in FIG. 4, the timing when the LED is emitting light is shown as high level, and the timing when the LED is not emitting light is shown as low level). In the first period 401, charge accumulation (photoelectric conversion) is performed over the exposure period based on the first exposure condition set in advance in the photoelectric conversion element. The photoelectric conversion in the first period is referred to as the first image capturing operation.

The second period 402-1 is the image capturing period (33.3 ms) of the frame 1 excluding the first period 401-1. The second period 402-1 is a period during which region specific exposure control is performed in accordance with the brightness of the image capturing target. The second exposure period 404-1 indicates the exposure period in the second period 402-1 set by the region specific exposure control. In this embodiment, the second exposure period 404-1 is half of the second period 402-1. Similar control is performed for the frame 2 following the frame 1. In the second period 402, charge accumulation is performed over the exposure period based on the second exposure condition decided for each pixel block. The photoelectric conversion in the second period is referred to as the second image capturing operation.

In the frame 2, an example is shown in which the exposure period 404-2 in the second period 402-2 is set to ⅛ of the second period 402-2 as a result of region specific exposure control. Hence, in the second period 404-2, the light emission period of the LED is not captured by the image sensor as shown in FIG. 4. If the light emission period of the LED is not captured by the image sensor, flickering can occur in the captured moving image.

The exposure periods of the image sensor in the first period 401 and the second period 402 are controlled by the exposure period controller 109 based on the exposure period 112 decided by the exposure condition decision unit 111 shown in FIG. 1. The light emission cycle T of the LED light source targeted for reducing flicker can be set in the register 142 from the external controller 10 and distributed as a register setting value 143. For the first image capturing operation, the exposure condition decision unit 111 uses the light emission cycle T, which is supplied as the register setting value 143, to decide the length of the first exposure period 403 in the first period 401. For the second image capturing operation, the exposure condition decision unit 111 decides the exposure condition for each region before the second image capturing operation is started. For example, the exposure period 404 in the second period 402 may be calculated based on an algorithm for calculating the exposure condition for each region, and based on the exposure image 122 in the second period 402 of the immediately preceding frame.

Note that the lengths of the first period 401 and the first exposure period 403 can be decided in accordance with the destination where this image capturing apparatus will be used as a product. The lengths of the first period 401 and the first exposure period 403 can be set in advance as data to be read by the external controller 10. It is also possible that the destination is determined using location information such as GPS and, when the image capturing apparatus is started up, the external controller 10 refers to a table corresponding to the location information and sets the data in the register 142. In addition, the lengths of the first period 401 and the first exposure period 403 can be set in accordance with the light emission cycle of the LED targeted for avoiding flicker.

In FIG. 3, the exposure image 122 in the first period 401-1 of the frame 1 shown in FIG. 4 is first input to the exposure correction unit 105. In this embodiment, an example will be described in which the image signal of the exposure image 122 is input to the exposure correction unit 105 in a Bayer array in which each set is formed by four pixels of an R pixel corresponding to red, a Gr pixel and a Gb pixel corresponding to green, and a B pixel corresponding to blue, as shown in FIG. 5. Note that the pixel set is not limited to the Bayer array. The pixels may be simply arranged in a matrix. Here, the image signal of the exposure image 122 in the first period of a given frame at a given pixel position is referred to as an image signal O1.

As described above, the image signal O1 includes four pixels of the R pixel, Gr pixel, Gb pixel, and B pixel. The calculation for the image signal O1 described below is applied independently to each of the four pixels of the R pixel, Gr pixel, Gb pixel, and B pixel for each pixel component. The data input as the data values of the image signal O1 are stored in the line buffer 301. When storing the data in the line buffer 301, the data are periodically thinned out in units of one Bayer array set arranged in a row (horizontal direction), and the remaining thinned-out data are stored in the line buffer 301. In this embodiment, the image signal O1 captured in the first period 401 is thinned out, and the remaining data are stored in the line buffer 301. Here, as shown in FIG. 5, every other data are thinned out in the horizontal direction (the horizontal line direction in FIG. 2) shown in FIG. 5 in units of one Bayer array set, and the remaining data are stored in the line buffer 301. In the example shown in FIG. 5, every other pixel data of the same color are thinned out, so that the amount of data stored in the line buffer 301 can be reduced by approximately half.

In the example shown in FIG. 5, a plurality of Bayer array sets are arranged in a row. Even numbers (0, 2, 4, . . . ) are assigned to the R pixels, Gr pixels, Gb pixels, and B pixels of the even-numbered Bayer array sets of the image signals O1 arranged in a row, starting from the beginning of the row. Each pixel assigned with the even number (to be referred to as the “even-numbered pixel” hereinafter) is stored in the line buffer 301. On the other hand, odd numbers (1, 3, . . . ) are assigned to the R pixels, Gr pixels, Gb pixels, and B pixels of the odd-numbered Bayer array sets of the image signals O1. In this embodiment, the image signal O1 from each pixel assigned with the odd number (to be referred to as the “odd-numbered pixel” hereinafter) is thinned out and not stored in the line buffer 301. Hereinafter, an even-numbered pixel in a given line is referred to as the 2nth pixel (n is 0 or a natural number), and an odd-numbered pixel is referred to as the (2n+1)th pixel. The output data corresponding to respective pixels, which are output in the first period, will be expressed as image signals O1₂ₙ, O1₂ₙ₊₁, and the like. Here, the image signal O1₂ₙ is an image signal in the first period, and means the image signal of the 2nth pixel arranged in a row, which is the even-numbered pixel.

In the example shown in FIG. 4, after the frame 1 starts and the first period 401-1 has elapsed, the data of the image signal O1 in the frame 1 are first stored in the line buffer 301. After the time of the second period 402-1 has elapsed, the exposure image 122 in the second period of the frame 1 is input. The image signal of the exposure image 122 in the second period of the same frame at this time is referred to as an image signal O2. The composite output data generated by the image adding unit 303 based on the image signal O1 and the image signal O2 is referred to as an image signal O3.

The image signal O3 is an image signal obtained by correcting the image signal O1 and the image signal O2 at a predetermined ratio and adding them. Similar to the image signal O1, each of the image signal O2 and the image signal O3 includes four pixels of the R pixel, Gr pixel, Gb pixel, and B pixel. In the following description, the calculation for the image signal O2 is applied independently to each of the four pixels of the R pixel, Gr pixel, Gb pixel, and B pixel for each pixel component.

At the time when the image signal O2 is supplied to the exposure correction unit 105 as the exposure image 122, if the image signal O1 in the same frame is stored in the line buffer 301, the image adding unit 303 reads out the image signal O1 from the line buffer 301 as a delay image 306. The image signal O1 is stored in the line buffer 301 if it is from the even-numbered pixel. In this case, the length of the data storing period in the line buffer 301 is equal to the length of the second period 402. For the data of the 2nth even-numbered pixel, the image signal O3₂ₙ is calculated as a composite output, which is a composite image signal of the image signal O2₂ₙ and the image signal O1₂ₙ, based on the following equation (1) and an adding ratio k calculated by the adding ratio calculation unit 302. Here, the adding ratio k is a value for correcting the image signal O2₂ₙ and the image signal O1₂ₙ by performing weighted addition based on the respective image capturing conditions. The adding ratio k will be described later. Note that in the following equation, for example, the data value of the image signal O1₂ₙ is expressed as O1₂ₙ.

$$O {3}_{2 n} = O {2}_{2 n} + k \times O {1}_{2 n} \qquad ( 1 )$$

On the other hand, for the odd-numbered pixel, at the time when the image signal O2 is supplied to the exposure correction unit 105 as the exposure image 122, the data of the image signal O1 at the same pixel position is not stored in the line buffer 301. Hence, the image adding unit 303 cannot read out the data of the image signal O1 from the line buffer 301 as the delay image 306. In this case, the data value of the image signal O3₂ₙ₊₁ corresponding to one frame is calculated based on:

$$O {3}_{2 n + 1} = G \times O {2}_{2 n + 1} \qquad ( 2 )$$

Here, G is a conversion ratio G 307 for converting the image signal O2₂ₙ₊₁ into the image signal O3₂ₙ₊₁. The conversion ratio G 307 can be calculated as the ratio of the length of the second period and the frame period λ by:

$$G = one frame period λ \div length of secod period \qquad ( 3 )$$

In this embodiment, as shown in FIG. 4, G can be obtained as follows:

$$G = 33.3 ms \div ( 11.1 ms + 11.1 ms ) = 33.3 / 22.2 = 1.5$$

The meaning of equation (2) is that, by multiplying the image signal O2₂ₙ₊₁ of the pixel obtained as a result of exposure in the second period by G, the data value of the pixel when the exposure condition for the second period is applied to one frame period is obtained. The value of the conversion ratio G 307 is also calculated by the adding ratio calculation unit 302 based on the register setting value 143, and given to the image adding unit 303.

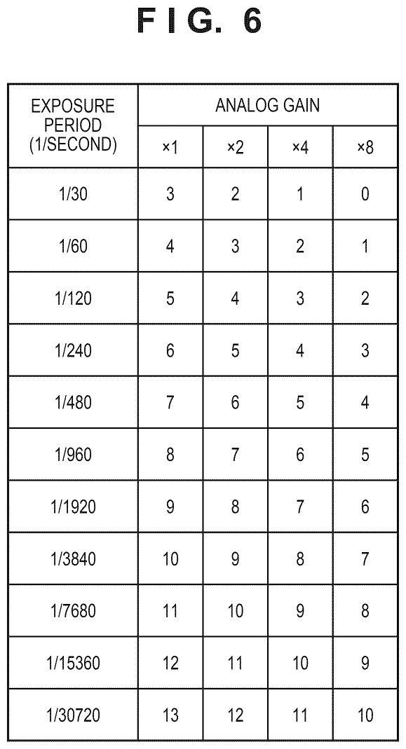

Next, the method of calculating the adding ratio k by the adding ratio calculation unit 302 will be described with reference to FIG. 6. FIG. 6 is a table showing the relationship among the exposure condition in region specific exposure control, the exposure period, and the analog gain. This table is a table applied when the frame rate is 30 fps in moving image capturing, and showing the relationship between the exposure period and the analog gain for the entire one frame period.

In FIG. 6, the number at the intersecting position of the analog gain in the vertical direction and the exposure period in the horizontal direction of the table is referred to as an EV value. The EV value is a power-of-two value that represents the ratio of brightness of an image capturing target based on the difference in exposure condition when the pixel signal level (pixel value) obtained by image capturing is the same. Assuming that the brightness of the image capturing target captured with an analog gain of ×8 and the exposure period of 1/30 sec is L0, a brightness LE of the image capturing target when the same pixel value is obtained by capturing it with an EV value E can be expressed by:

$$LE = L 0 \times 2 \hat{} E \qquad ( 4 )$$

Here, 2\hat{ }E indicates 2 to the Eth power (for example, 2\hat{ }3=8). For example, when the analog gain is ×1 and the exposure period is 1/30 sec, the EV value is 3. Similarly, when the analog gain is ×1 and the exposure period is 1/60 sec, the EV value is 4. This indicates that when the pixel values of the image signals obtained by image capturing are the same, the image capturing target captured under the condition with the EV value of 4 is twice as bright as the image capturing target captured under the condition with the EV value of 3.

Note that in the region specific exposure control, the table as shown in FIG. 6 is used to estimate the brightness of the image capturing target in a given region from the pixel value obtained in image capturing in the preceding frame and the exposure condition used in the image capturing, and the exposure condition to be used for image capturing in the next frame can be calculated.

Here, assume that the exposure condition used in the first period 401-1 of the frame 1 in FIG. 4 is that the analog gain is ×1 and the exposure period is fixed to the entire first period. If this exposure condition is applied to the entire frame, the exposure period is 1/30 sec, which corresponds to the entire frame, and the EV value in this case is 3 as shown in FIG. 6. On the other hand, in the exposure condition used in the second period 402-1 of the frame 1, the exposure period (second exposure period 404-1) is half of the second period 402-1. If this exposure condition is similarly applied to the entire frame, the exposure period is 1/60 sec, which corresponds to half of the entire frame. In this case, if the analog gain is ×4, the EV value is 2 as shown in FIG. 6.

This means that under the condition where it is originally determined appropriate to use an EV value of 2 for image capturing according to the region specific exposure control, image capturing is performed with an EV value of 3 in the first period 401-1. In the tone expansion unit 304 to be described later, the brightness of the pixel value is converted based on the EV value of 2 of the region specific exposure condition in the second period. Hence, the value of the image signal O1 captured with the EV value of 3 is converted into a value equivalent to that captured with the EV value of 2, and then added to the image signal O2. Thus, the value of the image signal for the entire one frame period is obtained. The coefficient used for this conversion is the adding ratio k. The adding ratio k can be calculated by:

$$k = 2 \hat{} ( EV value in first period ) \div 2 \hat{} ( EV value in second period ) = 2 \hat{} ( EV value in first period - EV value in second period ) \qquad ( 5 )$$

From equation (5), an adding ratio k1 in the frame 1 according to this embodiment is obtained as:

$$k 1 = 2 \hat{} ( 3 - 2 ) = 2 \hat{} 1 = 2$$

Similarly, consider the frame 2. The length of the second exposure period 404-2 of the frame 2 is ⅛ the length of the second period 402. This corresponds to the exposure period of 1/240 in FIG. 6. At this time, if the analog gain is ×1, the EV value in the second period 402-2 is 6. The EV value in the first period 401-2 is 3, which is the same as in the first period 401-1. This is because the exposure conditions in the first periods 401 are uniformly set to the same condition. An adding ratio k2 in the frame 2 at this time is obtained from equation (5).

$$k 2 = 2 \hat{} ( 3 - 6 ) = 2 \hat{} ( - 3 ) = 1 / 8$$

In FIG. 3, the image signal O3, which is the composite output of the image signal O2 and the image signal O1 calculated based on equation (1) by the image adding unit 303, is transmitted to the tone expansion unit 304. In the tone expansion unit 304, the EV value shown in FIG. 6 is obtained from the exposure period 112 and the analog gain value 113 of the corresponding pixel block. Letting E be the EV value at this time, the pixel value after tone expansion can be obtained by equation (4).

For example, as described above, the exposure condition in the second period of the frame 1 shown in FIG. 4 is that the exposure period is equivalent to 1/60 sec when the length of the second period is converted into the length of the entire frame 1, and the analog gain is ×4. The EV value in this case is 2. When the composite output of the frame 1 after adding processing is an image signal O31, and the pixel value after tone expansion is an image signal O41:

$$O 41 = O 31 \times 2 \hat{} 2 = 4 \times O 31$$

Similarly, as described above, the exposure conditions in the second period of the frame 2 shown in FIG. 4 is that the exposure period is equivalent to 1/240 sec when the length of the second period is converted into the length of the entire frame 2, and the analog gain is ×1. The EV value in this case is 6. When the composite output of the frame 2 after adding processing is an image signal O32, and the pixel value after tone expansion is an image signal O42:

$$O 42 = O 32 \times 2 \hat{} 6 = 64 \times O 32$$

In this case, if the original exposure image of the image signal O32 has a 10-bit width, the image signal O42 has a 16-bit width as a result of the calculation. In this embodiment, it can be seen that the EV value can be 13 at maximum in the example shown in FIG. 6. In that case, by performing tone expansion in the exposure correction unit 105, the data bit width increases. In this embodiment, the tone extended image 123 may have a 23-bit width at maximum. Thereafter, as described above, the tone conversion unit 106 generates, from the 23-bit tone extended image 123, for example, the 12-bit tone converted image 124 by gamma conversion.

In this embodiment, the data input as the data of the image signal O1 is thinned out in the horizontal direction in units of one Bayer array set, as shown in FIG. 5, and stored in the line buffer 301. However, it is also possible to thin out and output the image signal O1 when the image signal O1 is output from the imaging sensor 102. In this case, the imaging sensor 102 outputs the image signal O1 whose data amount is smaller, as the average of multiple pixels, than the data amount obtained at image capturing by the imaging sensor 102. The line buffer 301 at the subsequent stage only needs to store the small amount of data output without being thinned out. The control for thinning out the data before outputting it may be performed by a processing circuit (not shown) used for image capturing control provided in the imaging sensor 102.

Also in the case where the image signal is thinned out and output by the imaging sensor 102, the data output from the imaging sensor 102 is stored in the line buffer 301 at the subsequent stage as described above. The processing based on equations (1) and (2) can be performed similarly on the image signal stored in the line buffer 301. Hence, by reducing the data amount output from the imaging sensor 102, the storage capacity of the line buffer 301 at the subsequent stage can be reduced.

In this case, the data amount from the imaging sensor 102 based on the first image capturing operation has been thinned out, while the data amount based on the second image capturing operation has not been thinned out. Since the bit width of data output from imaging sensor 102 is the same between the first image capturing operation and the second image capturing operation, the data amount of the image signal based on the first image capturing operation output from the imaging sensor 102 can be smaller than the data amount of the image signal based on the second image capturing operation.

According to this embodiment, image processing is performed in which the image signal obtained by thinning out the image signal in the first period and the image signal in the second period are appropriately combined in one frame period. With this processing, even if a light source with a blinking period, such as an LED, is present in the image capturing range, it is possible to perform wide dynamic range (WDR) image capturing that takes advantage of the characteristics of region specific exposure control while suppressing flicker. For example, as in the frame 2 in FIG. 4, even if the light emission period of the LED cannot be captured in the second period in which region specific exposure control is performed, light emission of the LED is captured in the first period. Therefore, even in the image of the frame 2, which is a composite output of the output from the second period and the output from the first period, light emission of the LED is captured in the even-numbered pixels. This can prevent the image from appearing as if the LED light source is off. Furthermore, by appropriately thinning out and storing the data of the first period, it is possible to reduce the capacity of the memory unit required to store the image signals of the first period, which can contribute to miniaturization of the image capturing apparatus and cost reduction.

### Second Embodiment

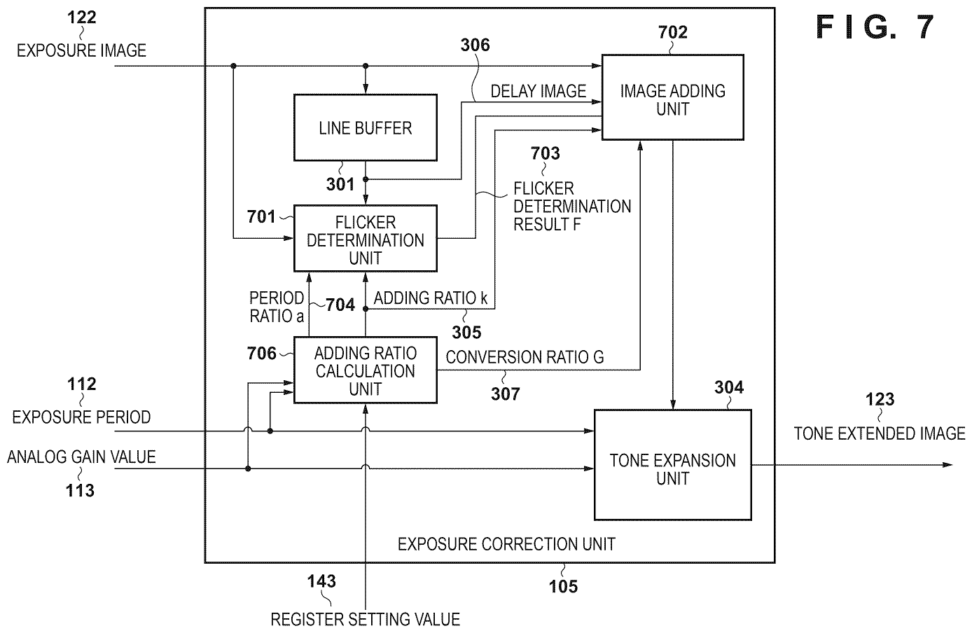

In the first embodiment, for the pixel of an even-numbered Bayer array set arranged in a row, the composite image signal generated from the output in the second period and the output in the first period is output as the image signal, and for the pixel of an odd-numbered Bayer array set, the image signal generated only from the output in the second period is output as the image signal. In this case, under the condition where flicker occurs, since the data in the first period 401 is thinned out for the pixel of the odd-numbered set, the presence of a light source causing flicker is not expressed, so that the smoothness of image display of the portion where flicker occurs can be lost. In this embodiment, an example will be described with reference to FIGS. 7 to 9, in which it is determined whether a light source causing flicker is present in the image capturing target, and the composite method for the pixel of the odd-numbered set is appropriately changed. Note that matters not mentioned below are similar to those in the first embodiment.

FIG. 7 is a block diagram showing an example of the configuration of an exposure correction unit 105 according to this embodiment. The exposure correction unit 105 includes a line buffer 301, an adding ratio calculation unit 706, a flicker determination unit 701, an image adding unit 702, and a tone expansion unit 304. The same reference numerals as in the first embodiment denote the constituent elements that have the same functions as those in the first embodiment.

The operation of each component of the exposure correction unit 105 shown in FIG. 7 will be described with reference to the example shown in FIG. 4. Note that a description of the same operations of the exposure correction unit 105 as in the first embodiment will be omitted, and differences from the first embodiment will be described here.

A description will be given assuming that, for example, an exposure image 122 in a first period 401-1 of a frame 1 shown in FIG. 4 is input to the exposure correction unit 105 in FIG. 7. Note that in this embodiment as well, the image signal of the exposure image 122 in the first period of a given frame at a given pixel position is referred to as an image signal O1. As in the first embodiment, the image signal O1 includes four pixels of an R pixel, a Gr pixel, a Gb pixel, and a B pixel of a Bayer array. In the following description, the calculation for the image signal O1 is applied independently to each of the four pixels of the R pixel, Gr pixel, Gb pixel, and B pixel for each pixel component.

The image signal O1 is input to the exposure correction unit 105 as the exposure image 122, and stored in the line buffer 301. When storing in the line buffer 301, the data are stored while being periodically thinned out in units of one Bayer array set in the horizontal direction as shown in FIG. 5. After the time of the second period has elapsed, the exposure image 122 in a second period 402-1 of the frame 1 is input. The image signal of the exposure image 122 in a second period 402 of the same frame as the image signal O1 is referred to as an image signal O2. The composite output data generated by the image adding unit 702 based on the image signal O1 and the image signal O2 is referred to as an image signal O3.

Similar to the image signal O1, each of the image signal O2 and the image signal O3 includes four pixels of the R pixel, Gr pixel, Gb pixel, and B pixel. In the following description, the calculation for the image signal O2 is applied independently to each of the four pixels of the R pixel, Gr pixel, Gb pixel, and B pixel for each pixel component, as in the description in the first embodiment.

At the time when the image signal O2 is supplied to the exposure correction unit 105 as the exposure image 122, if the image signal of the image signal O1 at the same pixel position is stored in the line buffer 301, the flicker determination unit 701 reads out the image signal O1 from the line buffer 301. This image signal O1 is read out as a delay image 306. Then, based on a period ratio α 704 and an adding ratio k 305 calculated by the adding ratio calculation unit 706, it is determined whether flicker has occurred at this pixel. A determination result F 703 regarding occurrence of flicker is transmitted to the image adding unit 702. The operation of the flicker determination unit 701 will be described later.

Whether there is flicker is determined at an even-numbered pixel. Determination as to whether there is flicker will be described below while expressing the exposure image 122 in the first period at an even-numbered pixel as an image signal O1₂ₙ, and the exposure image 122 in the second period at an even-numbered pixel as an image signal O2₂ₙ. In the image adding unit 702, the data of the delay image 306 as the image signal O1₂ₙ and the data of the image signal O2₂ₙ supplied as the exposure image 122 are delayed for the time required to calculate the flicker determination result F 703 in the flicker determination unit 701, thereby matching the timings of the adding ratio k 305, the image signal O1₂ₙ, and the image signal O2₂ₙ. After matching the timings, the image adding unit 702 calculates an image signal O3₂ₙ as a composite output using the flicker determination result F 703 from the flicker determination unit 701. In addition, the image adding unit 702 executes composite processing for the odd-numbered pixel following the even-numbered pixel by using the flicker determination result F 703 for the even-numbered pixel, thereby calculating an image signal O3₂ₙ₊₁ as a composite output. The operation of the image adding unit 702 will be described later.

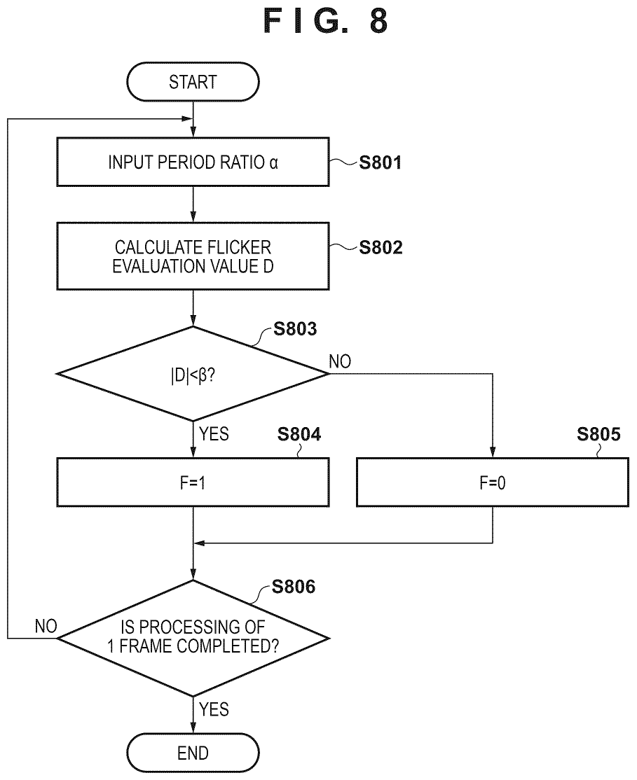

An example of calculation processing of the flicker determination result F 703 in the flicker determination unit 701 will be described with reference to the flowchart of FIG. 8. When the processing is started, the flicker determination unit 701 receives the period ratio α 704, which is the ratio of the second period and the first period, from the adding ratio calculation unit 706 (step S801). The ratio of the second period and the first period is calculated in the adding ratio calculation unit 706 based on a register setting value 143 input from a register 142. The period ratio α can be calculated by:

$$α = ( length of second period ) \div ( length of first period ) \qquad ( 6 )$$

In the example of this embodiment, the length of the second period is 22.2 ms and the length of the first period is 11.1 ms as shown in FIG. 4, thereby the period ratio α=2. The period ratio α may be calculated first for each frame, or may be calculated and set at the beginning of moving image capturing. The period ratio α is input to the flicker determination unit 701 (step S801). The adding ratio k 305 is calculated in the adding ratio calculation unit 706 based on equation (5) described in the first embodiment.

Using the period ratio α and the adding ratio k obtained as described above, the values of the image signal O2₂ₙ and the image signal O1₂ₙ are corrected. Using the second correction signal obtained by correcting the image signal O2₂ₙ and the first correction signal obtained by correcting the image signal O1₂ₙ, a flicker evaluation value D is calculated for each pixel (step S802). Using the image signal O2₂ₙ, the image signal O1₂ₙ, and the adding ratio k and the period ratio α calculated in the adding ratio calculation unit 706, the flicker evaluation value D can be calculated by:

$$D = O {2}_{2 n} \div k - α \times O {1}_{2 n} \qquad ( 7 )$$

As expressed by equation (7), in this embodiment, the difference between the second correction signal obtained by correcting the image signal O2₂ₙ with the adding ratio k and the first correction signal obtained by correcting the image signal O1₂ₙ with the period ratio α is obtained as the flicker evaluation value D. Then, based on the flicker evaluation value D, it is determined for each pixel whether flicker has occurred (step S803). Here, whether flicker has occurred is determined based on a threshold value p. If the absolute value of the flicker evaluation value D calculated in step S802 is smaller than the threshold value p, it is determined that no flicker has occurred (“YES” in step S803), and the processing advances to step S804; otherwise, it is determined that flicker has occurred (“NO” in step S803), and the processing advances to step S805.

In this embodiment, the threshold value p is a predetermined value given in advance, and set in the image adding unit 702. However, the method of setting the threshold value p is not limited to this, and it is also possible to change and use the value as required by, for example, setting it in the register 142 from the external controller 10. The flicker evaluation value D is compared with the threshold value p, and it is determined whether flicker has occurred based on whether the flicker evaluation value D is equal to or smaller than the threshold value p. Therefore, the threshold value p can be changed to an appropriate value, as appropriate.

If it is determined that no flicker has occurred, F=1 is set as a value indicating that no flicker has occurred (step S804). The value of F is transmitted to the image adding unit 702 as the flicker determination result F 703. On the other hand, if it is determined that flicker has occurred, F=0 is set as a value indicating that flicker has occurred (step S805). In this case as well, the value of F is transmitted to the image adding unit 702 as the flicker determination result F 703.

Then, it is determined whether the calculation processing of the flicker evaluation value D is completed for pixels of one frame (step S806). If the calculation processing is not completed for pixels of one frame (“NO” in step S806), the processing from step S801 is repeated. If the calculation processing is completed (“YES” in step S806), the processing is terminated.

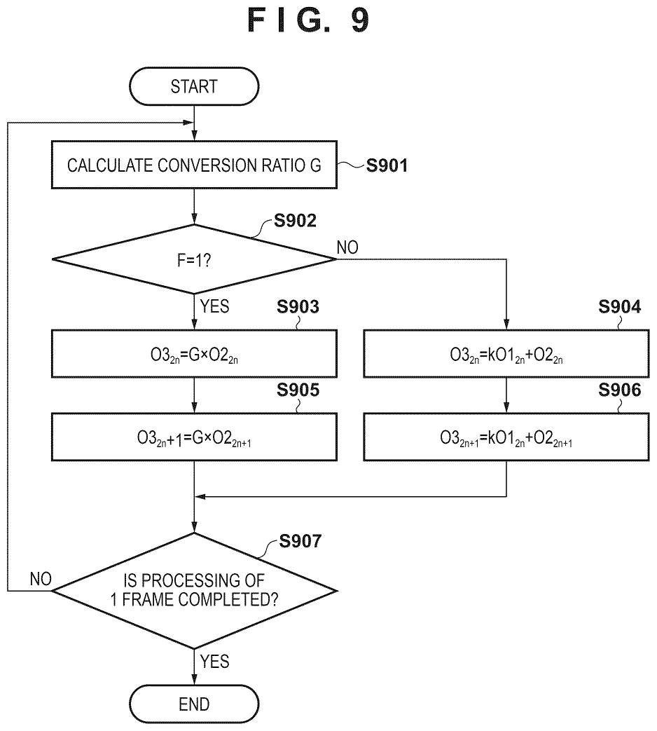

FIG. 9 is a flowchart showing an example of image adding processing in the image adding unit 702 according to the determination as to whether flicker has occurred. When the processing is started, a conversion ratio G, which is used when adding the image signals, is calculated (step S901). The conversion ratio G is a coefficient for converting the image signal O2₂ₙ of the even-numbered pixel obtained according to region specific exposure control into the pixel value in the same frame in a case where it is determined that there is no flicker. The conversion ratio G can be obtained by equation (3) as in the first embodiment. The conversion ratio G in this embodiment is G=1.5 as in the first embodiment. The conversion ratio G may be calculated first for each frame.

Then, referring to the flicker determination result F 703 for each pixel, a method of calculating the image signal O3 to be output is decided (step S902). If F=1 so no flicker has occurred (“YES” in step S902), the processing advances to step S903. On the other hand, if F=0 so that flicker has occurred at this pixel (“NO” in step S902), the processing advances to step S904.

In step S903, the image signal O3₂ₙ, which is to be output as the even-numbered pixel in a case where no flicker has occurred, is calculated using equation (8) described below. Then, the processing advances to step S905.

$$O {3}_{2 n} = G \times O {2}_{2 n} \qquad ( 8 )$$

In step S904, the image signal O3₂ₙ, which is to be output as the even-numbered pixel in a case where flicker has occurred, is calculated using equation (1) described in the first embodiment. After the processing in step S903 or step S904 is performed, composite processing of the output value for the odd-numbered pixel following this even-numbered pixel is executed.

In this embodiment, the exposure image 122 and the delay image 306 are continuously supplied to the image adding unit in a pipelined manner for each row in FIG. 7. In an example of the pipeline processing, when the image adding unit performs composite processing for the immediately preceding pixel, the exposure image 122 of the next pixel may be supplied to the line buffer 301. Accordingly, composite processing for the odd-numbered pixel 2n+1 following the even-numbered pixel 2n having undergone flicker determination can be executed smoothly. As described above, the flicker determination result F used to composite the output value of the odd-numbered pixel 2n+1 uses the determination result for the immediately preceding even-numbered pixel 2n. In the case where no flicker has occurred, an image signal O3₂ₙ₊₁ to be output as the odd-numbered pixel is calculated using equation (2) (step S905). Then, the processing advances to step S907.

In the case where flicker has occurred, the image signal O3₂ₙ₊₁ to be output as the odd-numbered pixel is calculated by equation (9) described below using the image signal O1₂ₙ of the immediately preceding even-numbered pixel in the first period (step S906). Then, the processing advances to step S907.

$$O {3}_{2 n + 1} = O {2}_{2 n + 1} + k \times O {1}_{2 n} \qquad ( 9 )$$

In step S907, it is determined whether the calculation processing of the image signal O3 is completed for pixels of one frame. If the calculation processing is not completed (“NO” in step S907), the processing from step S901 is repeated. If the calculation processing is completed (“YES in step S907), the processing is terminated.

Note that in this embodiment, in a case where flicker has occurred, the image signal O1 of the immediately preceding even-numbered pixel in the first period is used to composite the output value of the odd-numbered pixel. As another example, the average value for the even-numbered pixels before and after the odd-numbered pixel may be used to composite the output value thereof. In this case, in order to calculate the odd-numbered pixel, there is a need to read the even-numbered pixel following the odd-numbered pixel. Therefore, the overall image signal output timing is delayed by one pixel compared to the case where the value of the immediately preceding even-numbered pixel is used. At the right end of the image, calculation may be performed using only the immediately preceding pixel value as end portion processing. Note that the pixel interpolation method is not limited to these methods, and it goes without saying that various interpolation methods can be used.

The coordinates, in an image sensor unit 103, of the pixel where flicker has occurred can be specified. During the next frame capturing, flicker is likely to occur in pixels at coordinates around the pixel where flicker has occurred in the image sensor unit 103. The image sensor unit 103 may be driven so as to perform the first image capturing operation only for the pixels around the coordinates where flicker is likely to occur, and perform only the second image capturing operation for the pixel where flicker is not likely to occur. By driving in this manner, the imaging sensor 102 outputs the image signals O1 only from coordinates where flicker is likely to occur. Accordingly, the data amount of the image signals O1 output from the imaging sensor 102 can be made smaller than the data amount of the image signals O2.

According to this embodiment, it is possible to determine whether a light source causing flicker is present in the image capturing target, and adaptively change the composite ratio of the second period and the first period. This makes it possible to obtain an image that is more suitable as a WDR image. In addition, in a case where flicker has occurred, it is possible to generate a composite image by appropriately using the image signal O1 of the even-numbered pixel as the interpolated value. Accordingly, the required capacity of the memory unit can be reduced by appropriately thinning out and storing the image signals in the first period, and the image of the portion corresponding to the flicker light source unit can be displayed smoothly. According to this embodiment, miniaturization of the image capturing apparatus and cost reduction can be implemented.

### Third Embodiment

In the first embodiment, the example has been described in which, when storing in the line buffer 301, the data input as the image signal O1 are stored while being thinned out in units of one Bayer array set in the horizontal direction as shown in FIG. 5. For an even-numbered pixel, the composite image signal generated from the output in the second period and the output in the first period is output as the image signal, and for an odd-numbered pixel, the image signal generated only from the output in the second period is output as the image signal. In this case, under the condition where flicker occurs, since the image signal in the first period is thinned out for the odd-numbered pixel, the presence of a light source causing flicker is not expressed, so that the smoothness of image display can be lost.

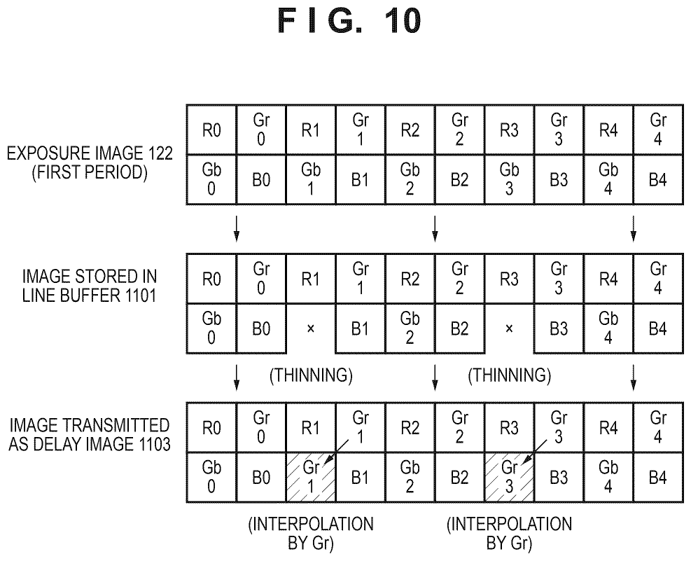

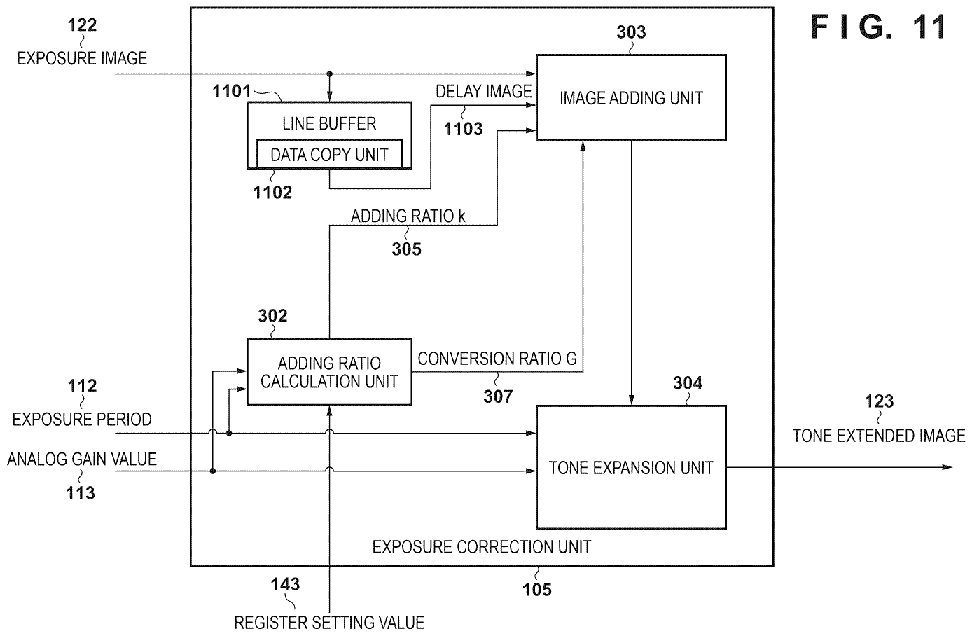

In this embodiment, by changing the method of thinning out image signals upon storing in a line buffer 1101, a composite signal of an image signal captured in the first period and an image signal captured in the second period can be always generated in one frame period. According to this embodiment, it is possible to reduce the data amount stored in the memory while maintaining the smoothness of image display of the portion where flicker has occurred. With reference to FIGS. 10 and 11, this embodiment will be described. Note that differences from the first embodiment will mainly be described below, and a description of portions similar to those in the first embodiment will be omitted. The drawing in the first embodiment will be used for description where the same drawing as in the first embodiment can be used for description.

FIG. 11 is a block diagram showing an example of the configuration of an exposure correction unit 105 according to this embodiment. This embodiment will be described assuming that an exposure image 122 in a first period 401 of a frame 1 shown in FIG. 4 is first input to the exposure correction unit 105 in FIG. 11. In this embodiment, an example will be described in which the image signal of the exposure image 122 is input to the exposure correction unit 105 in a Bayer array set including four pixels of an R pixel, a Gr pixel, a Gb pixel, and a B pixel as shown in FIG. 10. Here, the image signal of the exposure image 122 in a first period 401 of a given frame at a given pixel position is referred to as an image signal O1.

As described above, the image signal O1 includes four pixels of the R pixel, Gr pixel, Gb pixel, and B pixel. In the following description, the calculation for the image signal O1 is applied independently to each of the four pixels of the R pixel, Gr pixel, Gb pixel, and B pixel for each pixel component. When storing in the line buffer 1101, from the data input as data corresponding to the image signal O1, data of one color among the RGB pixels of Bayer array are periodically thinned out, and the remaining data are stored in the line buffer 1101. In the example shown in FIG. 10, the data are stored while only the image signals of the Gb pixels of odd-numbered pixels are thinned out every other pixel.

After the frame 1 starts and a first period 401-1 has elapsed, the data of the image signal O1 are first stored in the line buffer 1101. After the time of a second period 402-1 has elapsed, the exposure image 122 in the second period of the frame 1 is input. The image signal of the exposure image 122 in the second period 402-1 of the same frame 1 at this time is referred to as an image signal O2. The composite output data generated by an image adding unit 303 based on the image signal O1 and the image signal O2 is referred to as an image signal O3.

Each of the image signal O2 and the image signal O3 includes four pixels of the R pixel, Gr pixel, Gb pixel, and B pixel, similar to the image signal O1. In the following description, the calculation for the image signal O2 is applied independently to each of the four pixels of the R pixel, Gr pixel, Gb pixel, and B pixel for each pixel component. This is the same as in the case of the image signal O1.

At the time when the image signal O2 is supplied to the exposure correction unit 105 as the exposure image 122, the image adding unit 303 reads out the image signal O1 from the line buffer 1101 as a delay image 1103. Here, the line buffer 1101 includes a data copy unit 1102 at the output stage. The data copy unit 1102 has a function of, when the pixel to be output is an odd-numbered pixel, copying the data of the Gr pixel of the odd-numbered pixel of the same Bayer array set to the image position of the thinned-out pixel Gb. Hence, in the image signal transmitted to the image adding unit 303 as the delay image 1103, the odd-numbered pixel in the Bayer array set has the data of the Gr pixel at the image position of the Gb pixel of the same odd-numbered pixel, as shown in FIG. 10. In place of the data of a thinned-out Gb1 pixel, the data of a Gr1 pixel is copied as indicated by an arrow. In place of the data of a thinned-out Gb3 pixel, the data of a Gr3 pixel is copied as indicated by an arrow.

Then, the image adding unit 303 calculates the image signal O3 as a composite output, which is the composite image signal of the image signal O2 and the image signal O1, based on the following equation (10) and an adding ratio k (305) calculated by an adding ratio calculation unit 302. In this embodiment, equation (10) is used to calculate the image signal O3 for both the odd-numbered pixel and the even-numbered pixel. Equation (10) is a modification of equation (1) in the first embodiment so as to be applicable to the odd-numbered pixel.

$$O 3 = O 2 + k \times O 1 \qquad ( 10 )$$

The remaining operation is similar to that in the first embodiment, so that a description thereof will be omitted. Note that in this embodiment, as a method of interpolating the Gb pixel of the odd-numbered pixel by the data copy unit 1102, the data of the Gr pixel of the same odd-numbered pixel is copied. However, the interpolation method is not limited to the method disclosed here. In another example, when generating the data at the position of the Gb1 pixel, a method of interpolating it while referring to the data of nearby Gb0 pixel, Gr0 pixel, Gr1 pixel, and Gb2 pixel can be adopted.

Note that in this embodiment, the data input as the image signal O1 are stored in the line buffer 1101 while only the Gb pixel of each odd-numbered pixel is thinned out, as shown in FIG. 10. However, when an imaging sensor 102 outputs the image signal O1, it may output the data having undergone thinning processing in the imaging sensor 102. A processing circuit (not shown) used for image capturing control provided in the imaging sensor 102 may be used for the thinning processing. In this case as well, since the data without thinning can be stored in the line buffer 1101 and the subsequent processing can be executed as described above, an effect similar to the effect according to this embodiment can be obtained.

According to this embodiment, it is possible to simultaneously implement reduction of the required capacity of the memory unit by appropriately thinning out and storing the data in the first period, and smooth image display of the flicker portion. This can contribute to miniaturization of the image capturing apparatus and cost reduction.

### Fourth Embodiment

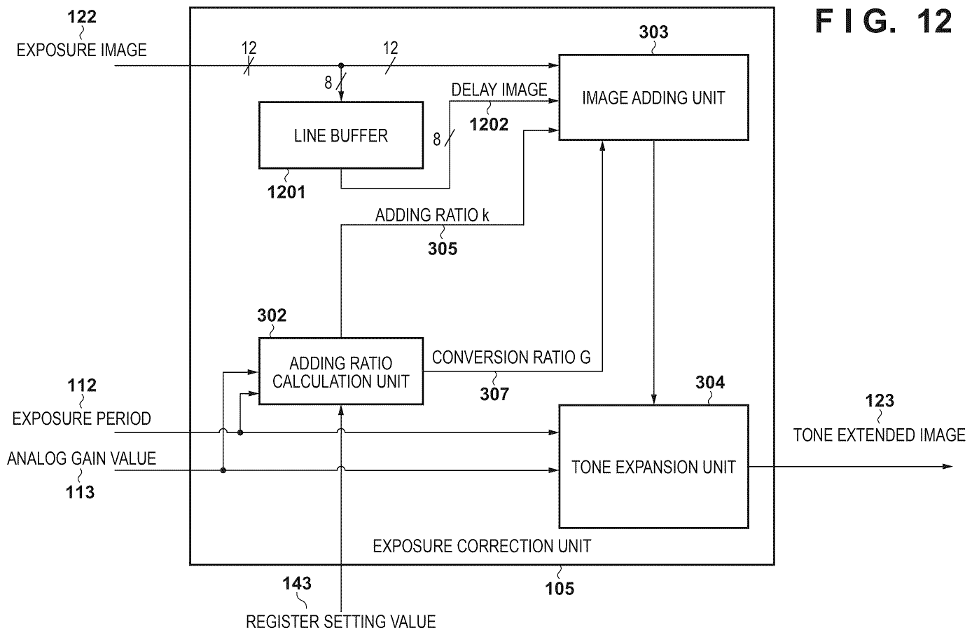

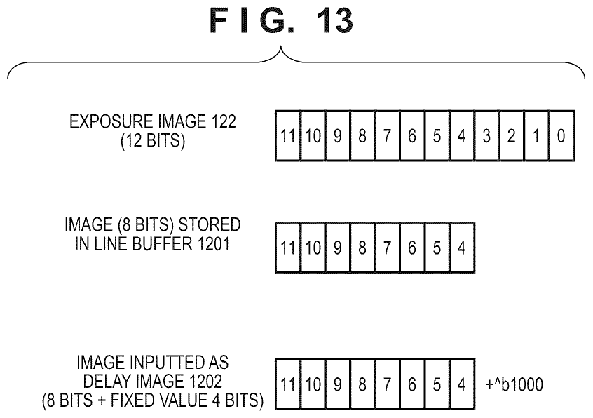

With reference to FIGS. 12 and 13, an example will be described in which, as the data stored in a line buffer 1201, only the data of a predetermined number of upper bits of the image signal in each pixel are stored in the line buffer 1201. Note that matters not mentioned below are similar to those in the first and third embodiments, and the drawing in the first embodiment will be used for description where the same drawing as in the first embodiment can be used for description.

FIG. 12 is a block diagram showing an example of the configuration of an exposure correction unit 105 according to this embodiment. In FIG. 12, an exposure image 122 in a first period 401 of a frame 1 shown in FIG. 4 is first input to the exposure correction unit 105. In this embodiment, the image signal of the exposure image 122 is 12-bit width data as shown in FIG. 13. That is, in this example, each of four pixels of an R pixel, a Gr pixel, a Gb pixel, and a B pixel has a 12-bit data width.

Here, the image signal of the exposure image 122 in the first period 401 of a given frame at a given pixel position is referred to as an image signal O1. As described above, the image signal O1 includes four pixels of the R pixel, Gr pixel, Gb pixel, and B pixel. In the following description, the calculation for the image signal O1 is applied independently to each of the four pixels of the R pixel, Gr pixel, Gb pixel, and B pixel for each pixel component.

With reference to the example shown in FIG. 13, this embodiment will be described. The data input as the image signal O1 is 12-bit data indicated by 11 to 0 from the upper bit to the lower bit as shown as the exposure image 122. When storing this data in the line buffer 1201, only the upper 8 bits indicated by 11 to 4 of the image signal are stored as shown in FIG. 13. Only the upper eight bits of each of the four pixels of the R pixel, Gr pixel, Gb pixel, and B pixel are stored in the line buffer 1201.

After the frame 1 starts and a first period 401-1 has elapsed, as described above, only the data of the upper eight bits of the image signal O1 are first stored in the line buffer 1201. After the time of a second period 402-1 has elapsed, the exposure image 122 (corresponding to a second exposure period 404-1) in the second period 402-1 of the frame 1 is input. The image signal of the exposure image 122 in the second period 402-1 of the same frame 1 at this time is referred to as an image signal O2. The image signal O2 has a 12-bit width, and is input to an image adding unit 303. Here, the composite output data generated by the image adding unit 303 based on the image signal O1 and the image signal O2 is referred to as an image signal O3.

Similar to the image signal O1, each of the image signal O2 and the image signal O3 includes four pixels of the R pixel, Gr pixel, Gb pixel, and B pixel. In the following description, the calculation for the image signal O2 is applied independently to each of the four pixels of the R pixel, Gr pixel, Gb pixel, and B pixel for each pixel component, similar to the image signal O1.

At the time when the image signal O2 is supplied to the exposure correction unit 105 as the exposure image 122, the image adding unit 303 reads out the data of the image signal O1 from the line buffer 1201 as a delay image 1202. At this time, the image read out from the line buffer as the delay image 1202 is 8-bit data. When the delay image 1202 is input to the image adding unit 303, it is input while the lower four bits are compensated with a binary value of “1000” (to be also written as “\hat{ }b1000”) as shown in FIG. 13. This value for the lower four bits can be implemented by fixing, of the lower four bits, bit 3 of the input terminal of the input signal line of the image adding unit 303 to H and bits 2 to 0 to L.

Then, the image adding unit 303 calculates the image signal O3 as the composite image signal of the image signal O2 and the image signal O1 based on equation (10) described in the third embodiment and an adding ratio k 305 calculated by an adding ratio calculation unit 302. Also in this embodiment, as in the third embodiment, the equation (10) is used to calculate the image signal O3 for both the odd-numbered pixel and the even-numbered pixel. The subsequent operation is similar to that in the first and third embodiments described above, so that a description thereof will be omitted.

In this embodiment, the exposure image 122 has the 12-bit width, and the upper eight bits thereof are stored in the line buffer 1201. The data bit width and the bit width to be stored in the line buffer are merely examples, and can be appropriately selected in accordance with the system configuration, data needs, and the like.

Note that in this embodiment, a binary value of “1000” is used as the value for compensating for the lower bits of the delay image 1202, but it is also possible to use “0111” in some cases. These two values are intermediate values between 0 and 15 expressed by four bits. By using the intermediate value as the lower bits, when subsequently calculating the image signal O3, the average expected value of the error from the value of the image signal O3, which is obtained if the original lower bits are present, can be minimized.

In addition, in this embodiment, when storing the data input as the image signal O1 in the line buffer 1201, only the upper bits of the pixel value are stored as shown in FIG. 13. It is also possible that an imaging sensor 102 outputs only a predetermined number of upper bits of the pixel when it outputs the image signal O1. More specifically, the imaging sensor 102 can be made to output only the upper eight bits of the data. In this case as well, by storing the upper bit data in the line buffer 1201 and executing the subsequent processing as described above, the effect according to this embodiment can be obtained.

According to this embodiment, by appropriately thinning out and storing the data of the image signal in the first period, it is possible to reduce the required capacity of the memory unit, and perform wide dynamic range (WDR) image capturing that takes advantage of the characteristics of region specific exposure control while suppressing flicker. This can contribute to miniaturization of the image capturing apparatus and cost reduction.

### Fifth Embodiment

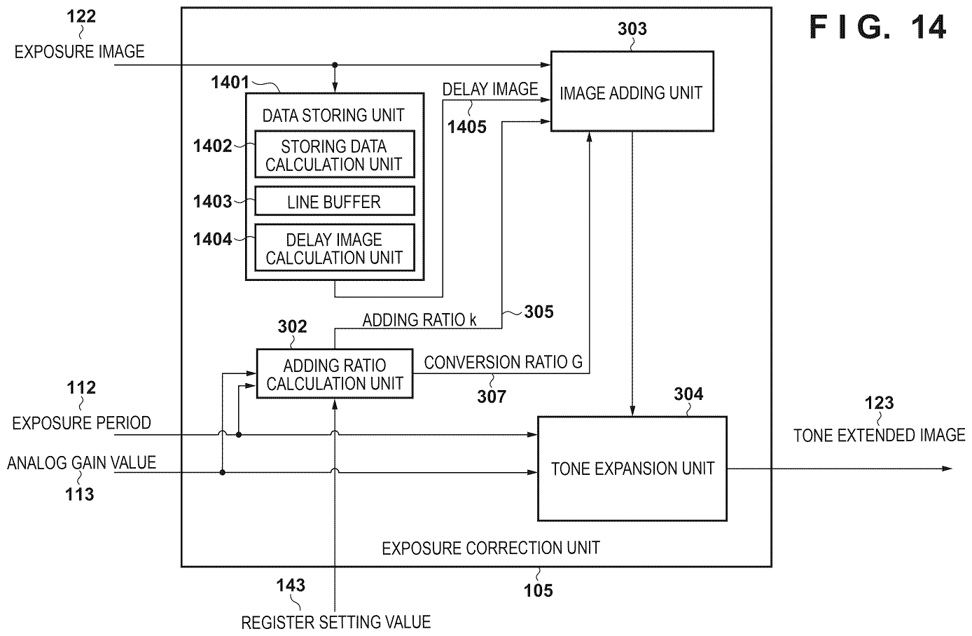

In this embodiment, the difference data from the adjacent pixel arranged in the same row is stored in a line buffer 1403, thereby reducing the data amount stored in the memory while further decreasing the error between images before and after thinning. With reference to FIGS. 14 to 17, this example will be described. Note that matters not mentioned below are similar to those in the first, third, and fourth embodiments described above. The drawing in each embodiment will be used for description where the same drawing as in each of the first, third, and fourth embodiments can be used for description.

FIG. 14 is a block diagram showing an example of the configuration of an exposure correction unit 105 according to this embodiment. In FIG. 14, an exposure image 122 in a first period 401-1 of a frame 1 shown in FIG. 4 is first input to the exposure correction unit 105. In this embodiment, the image signal of the exposure image 122 is 12-bit width data, similar to that shown in FIG. 13 of the fourth embodiment. In an example where pixels are arranged in a Bayer array, this means that each of four pixels of an R pixel, a Gr pixel, a Gb pixel, and a B pixel has 12-bit width data. Here, the image signal of the exposure image 122 in the first period 401-1 of a given frame at a given pixel position is referred to as an image signal O1. As described above, the image signal O1 includes four pixels of the R pixel, Gr pixel, Gb pixel, and B pixel. In the following description, the calculation for the image signal O1 is applied independently to each of the four pixels of the R pixel, Gr pixel, Gb pixel, and B pixel for each pixel component.

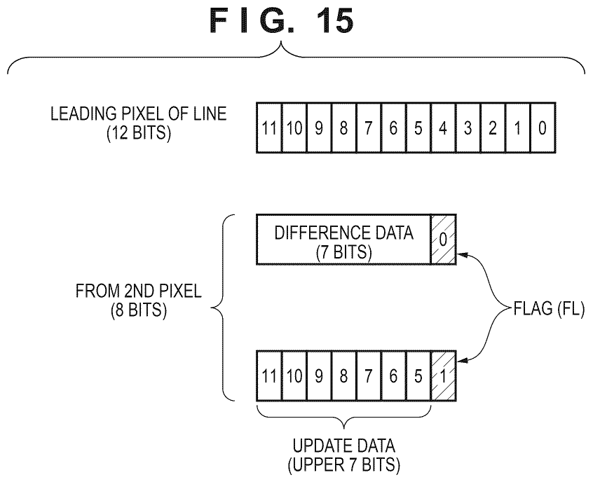

When storing in a data storing unit 1401, the data input as the image signal O1 are stored in the line buffer 1403 in the data storing unit 1401 in the format shown in FIG. 15. This means that each of the four pixels of the R pixel, Gr pixel, Gb pixel, and B pixel is stored in the format shown in FIG. 15.

When the data of the exposure image 122 is input to the data storing unit 1401 as the image signal O1, the data is processed by a storing data calculation unit 1402, and input to the line buffer 1403. The operation of the storing data calculation unit 1402 will be described later.

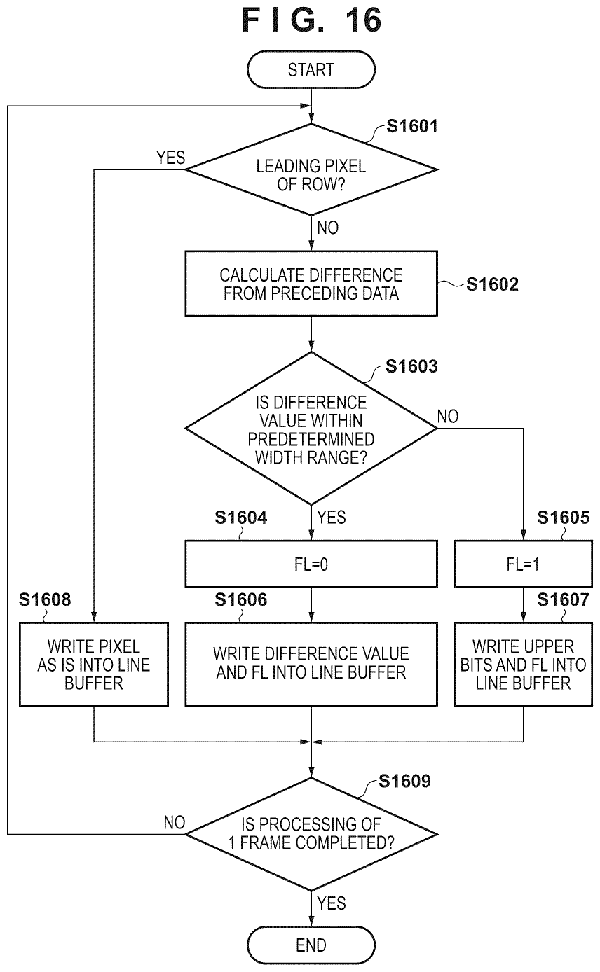

FIG. 16 is a flowchart showing an example of processing of calculating, in the storing data calculation unit 1402, data to be stored in the line buffer 1403 from the exposure image 122 of the image signal O1. Note that this operation is executed in parallel on the four pixels of the R pixel, Gr pixel, Gb pixel, and B pixel input in a Bayer format. In step S1601, it is determined whether the input pixel is the leading pixel (leftmost pixel) in the image row. If the input pixel is the leading pixel in the row (YES in step S1601), the processing transitions to step S1608 without processing the pixel value from the pixel. In step S1608, the pixel value is written as is in the leading area of the line buffer. Then, the processing advances to step S1609.

If the input pixel is not the leading pixel in the row (NO in step S1601), the processing advances to step S1602. In step S1602, a difference value 6 from the immediately preceding pixel value of the same color component is calculated, and the processing advances to step S1603. In step S1603, it is determined whether the magnitude of the difference value 6 calculated in step S1602 is within a range of a predetermined bit width. For example, assume that the difference data expressed by seven bits is to be stored in the line buffer 1403, as shown in FIG. 15. In this case, when the difference data is expressed in two's complement, numbers expressed by seven bits range from −64 to +63 (7F to 3F). Hence, if −64≤δ≤+63 (YES in step S1603), the processing advances to step S1604. If δ<−64 or 63<δ (NO in step S1603), the processing advances to step S1605.

In each of steps S1604 and S1605, a flag FL is set, which indicates whether the data of the second or subsequent pixel in the row to be stored in the line buffer 1403 is difference data or update data. Here, the difference data is the difference value 6 from the immediately preceding pixel value of the same color component, which falls within the range of the predetermined bit width. The update data is data which is stored when the difference value 6 falls outside the predetermined bit width. Storing the update data will be described later. In step S1604, FL=0 is set to indicate that the data to be stored in the line buffer 1403 is the difference data. In step S1605, FL=1 is set to indicate that the data to be stored in the line buffer 1403 is the update data. Then, the processing advances from step S1604 to step S1606 or from step S1605 to step S1607.

In step S1606, since the difference value 6 falls within the range of the predetermined bit width, the difference value obtained in step S1602 and the flag FL=0 are stored in the line buffer 1403 in the format shown in FIG. 15. Then, the processing advances to step S1609. In step S1607, since the difference value 6 falls outside the range of the predetermined bit value, instead of the difference value 6, the upper seven bits of the input pixel value and the flag FL=1 are stored in the line buffer 1403 in the format shown in FIG. 15. Then, the processing advances to step S1609. In step S1609, it is confirmed whether the processing for one frame is completed. If the processing is not completed (NO in step S1609), the processing returns to step S1601, and the operation is repeated. If the processing is completed (YES in step S1609), the processing is terminated.

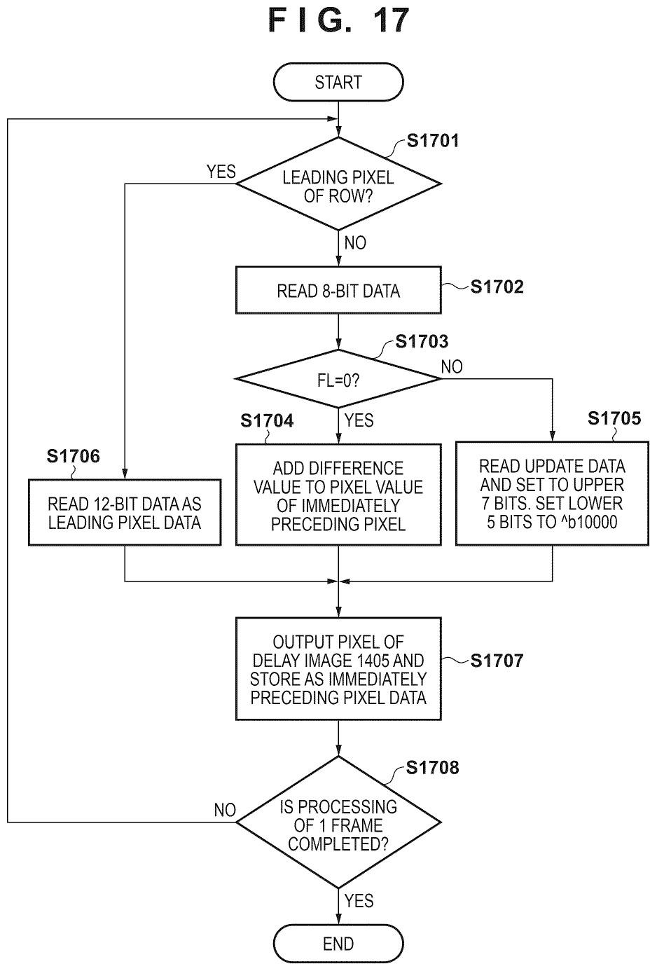

FIG. 17 is a flowchart showing an example of the processing of reading out the data stored in the line buffer 1403 and calculating a delay image 1405 in a delay image calculation unit 1404. Note that this operation is executed in parallel on the four pixels of the R pixel, Gr pixel, Gb pixel, and B pixel input in a Bayer format. In step S1701, it is determined whether the pixel to be read out is the leading pixel (leftmost data) in the image row. If it is the leading pixel in the row (YES in step S1701), the processing advances to step S1706. In step S1706, the leading pixel in the row is read out as 12-bit data, and the processing advances to step S1707. In step S1707, the readout 12-bit data is output as the leading pixel value of the delay image 1405, and stored for use in calculation of the next pixel.

If it is not the leading pixel in the row (NO in step S1701), the processing advances to step S1702. In step S1702, since it is not the leading pixel in the row, the pixel value is read out as 8-bit data, and the processing advances to step S1703. In step S1703, it is determined whether the value of the flag FL is 0 or 1. If FL=0 (YES in step S1703), this indicates that the readout data is the 7-bit difference data, and the processing advances to step S1704. In step S1704, data to be output is generated by adding the difference data and the stored data of the immediately preceding pixel, and the processing advances to step S1707. On the other hand, if FL=1 (NO in step S1703), this indicates that the readout data is the 7-bit update data, and the processing advances to step S1705.

In step S1705, the readout 7-bit update data is set in the upper seven bits of the 12-bit delay image signal. At the same time, the lower five bits are compensated with a binary value of “10000”. The delay image signal to be output is prepared in this manner, and the processing advances to step S1707. As described above, in step S1707, the pixel value prepared as the data of the delay image 1405 to be output is output, and stored for use in calculation of the next pixel. Then, the processing advances to step S1708. In step S1708, it is confirmed whether the processing for one frame is completed. If the processing is not completed (NO in step S1708), the processing returns to step S1701, and the operation is repeated. If the processing is completed (YES in step S1708), the processing is terminated. The output delay image 1405 is input to an image adding unit 303, and a composite output O3 is generated by the method described in the fourth embodiment. The subsequent operation is similar to that in the fourth embodiment, and a description thereof will be omitted.

In this embodiment, the exposure image 122 has a 12-bit width, and the data of the second or subsequent pixel is stored in the line buffer 1403 with seven bits as difference data or update data and one bit as flag data. The data bit width and the bit width stored in the line buffer are merely examples, and can be appropriately selected in accordance with the system configuration.

Note that in this embodiment, the binary value of “10000” is used as the value for compensating for the lower bits when using the update data, but it is also possible to use “01111” to compensate for the lower bits in some cases. These two values are intermediate values between 0 and 31 expressed by five bits. When subsequently calculating the image signal O3, this can minimize the average expected value of the error from the value of the image signal O3, which is obtained if the original lower bits are present.

In addition, in this embodiment, the difference value 6 from the immediately preceding pixel value of the same color component is calculated, and the value 6 is used as is as the difference data. However, it is also possible to add an offset to the difference value in some cases. For example, if a value of δ/4 (round down decimals) is used for the data to be stored as the difference value, and the difference data is expressed in two's complement, −64≤δ/4≤+63, that is, −256≤6≤+252 may be used. In this case, if δ falls outside this range, the update data is stored. If δ falls within this range, the delay image calculation unit executes calculation considering the offset (in this case, considering that 6 is divided by 4, that is, the difference value is shifted by two bits).

Furthermore, in this embodiment, the delay image calculation unit 1404 is provided in the data storing unit 1401, but the image adding unit 303 can have the function of the delay image calculation unit, depending on the configuration. Alternatively, when the image signal O1 is output from an imaging sensor 102, the difference of the image signal O1 may be output and the image signal may be stored in the line buffer 301 to perform similar processing. Even with this configuration, an effect similar to the effect according to this embodiment can be obtained.

According to this embodiment, by storing the data in the line buffer 1403 based on the difference data from the preceding pixel, it is possible to reduce the data amount stored in the memory while decreasing the error between images before and after thinning. Thus, it is possible to perform wide dynamic range (WDR) image capturing that takes advantage of the characteristics of region specific exposure control while suppressing flicker. This can contribute to miniaturization of the image capturing apparatus and cost reduction.

### [Application of System According to Embodiment to Equipment]

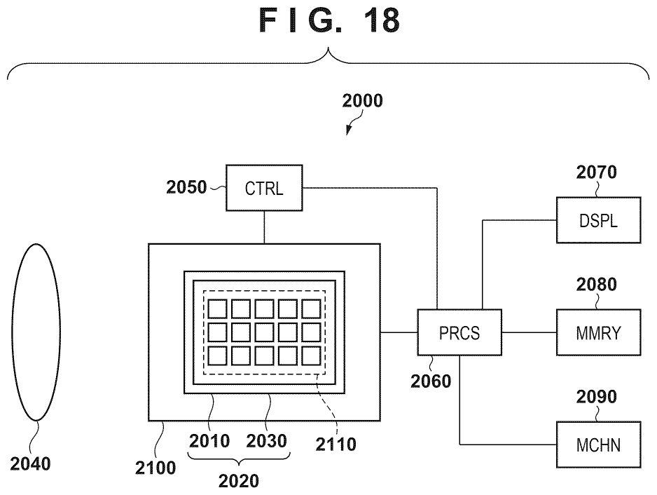

The following is a description of equipment 2000 that includes a semiconductor apparatus 2100 including a package 2020 on which a semiconductor chip 2110 including a semiconductor integrated circuit is mounted, as shown in FIG. 18. The semiconductor chip 2110 is accommodated in the package 2020 and mounted on the equipment 2000. In the arrangement shown in FIG. 18, the semiconductor chip 2110 includes the photoelectric conversion system according to the embodiment described above. The semiconductor apparatus 2100 can include the package 2020 including a base 2010 on which the semiconductor chip 2110 is fixed and a light transmissive member 2030 such as glass that faces the semiconductor chip 2110. The package 2020 can be provided with joining members such as wires and bumps that connect inner leads provided on the base 2010 to terminals such as pad electrodes provided on the semiconductor chip 2110.

The equipment 2000 can include at least one of an optical apparatus 2040, a control apparatus 2050, a processing apparatus 2060, a display apparatus 2070, a storage apparatus 2080, and a mechanical apparatus 2090. The optical apparatus 2040 is implemented by, for example, a lens, a shutter, and a mirror. The control apparatus 2050 controls the semiconductor chip 2110. The control apparatus 2050 may be formed by, for example, a semiconductor device such as an ASIC.

The processing apparatus 2060 processes a signal output from the image capturing apparatus included in the semiconductor chip 2110. The processing apparatus 2060 is a semiconductor device such as a CPU or an ASIC for forming an Analog Front End (AFE) or a Digital Front End (DFE). The processing apparatus 2060 may generate an image based on an event signal. The display apparatus 2070 is an EL display device or a liquid crystal display device that displays an information image obtained by the semiconductor chip 2110. The storage apparatus 2080 is a magnetic device or a semiconductor device that stores the information image obtained by the semiconductor chip 2110. The storage apparatus 2080 is a volatile memory such as an SRAM or a DRAM, or a nonvolatile memory such as a flash memory or a hard disk drive.

The mechanical apparatus 2090 can include a moving or propulsion unit such as a motor or an engine. In the equipment 2000, the signal output from the semiconductor chip 2110 can be displayed on the display apparatus 2070 or transmitted to an external apparatus by a communication apparatus (not shown) included in the equipment 2000. Hence, the equipment 2000 may further include the storage apparatus 2080 and the processing apparatus 2060 in addition to the memory circuits and arithmetic circuits included in the semiconductor chip 2110. The mechanical apparatus 2090 may be controlled based on the signal output from the semiconductor chip 2110.

In addition, the equipment 2000 may be an information terminal which has an image capturing function, or electronic equipment such as a smartphone or a wearable terminal. The equipment 2000 may be a camera. The camera may include an interchangeable lens camera, a compact camera, a video camera, a monitoring camera, and the like. The mechanical apparatus 2090 in the camera can drive the components of the optical apparatus 2040 in order to perform zooming, an in-focus operation, and a shutter operation. Alternatively, the mechanical apparatus 2090 in the camera can move the optical apparatus 2040 in order to perform an anti-vibration operation.

Furthermore, the equipment 2000 can be transportation equipment such as a vehicle, a ship, or an airplane. The mechanical apparatus 2090 in the transportation equipment can be used as a moving apparatus. The equipment 2000 as the transportation equipment is suitable for an apparatus that transports the semiconductor chip 2110 or an apparatus that uses an image capturing function to assist and/or automate drive steering. The processing apparatus 2060 for assisting and/or automating drive steering can perform, based on the information obtained by the semiconductor chip 2110, processing for operating the mechanical apparatus 2090 as a moving apparatus. Alternatively, the equipment 2000 may be medical equipment such as an endoscope, measurement equipment such as a distance measurement sensor, analysis equipment such as an electron microscope, office equipment such as a copy machine, or industrial equipment such as a robot.

### OTHER EMBODIMENTS

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-202616, filed Nov. 20, 2024 which is hereby incorporated by reference herein in its entirety.

What is claimed is:

1. A photoelectric conversion system comprising a photoelectric conversion apparatus that includes an image sensor arranged with a plurality of pixel blocks in which a plurality of pixels are arranged in a matrix, and a memory unit,
wherein
in one frame period, the photoelectric conversion apparatus performs a first image capturing operation that includes an exposure period based on a first exposure condition set in advance, and a second image capturing operation for which an exposure period is controlled based on a second exposure condition decided for each pixel block, and
the memory unit stores a first image signal having a data amount smaller than a data amount of an image signal acquired by the photoelectric conversion apparatus by the first image capturing operation.

2. The system according to claim 1, further comprising a signal generation unit configured to generate a third image signal corresponding to the one frame period based on the first image signal stored in the memory unit and a second image signal acquired by the second image capturing operation.

3. The system according to claim 2, wherein the signal generation unit generates the third image signal by performing weighted addition on the first image signal stored in the memory unit and the second image signal at a predetermined ratio for each pixel.

4. The system according to claim 1, wherein the memory unit stores the first image signal until a second image signal acquired by the second image capturing operation is output from the photoelectric conversion apparatus.

5. The system according to claim 1, wherein the pixel block includes pixels that output signals corresponding to a plurality of different colors, and the memory unit stores image signals that remains after periodically thinning out image signals of pixels of the same color in the same row from image signals acquired by the first image capturing operation.

6. The system according to claim 1, wherein the pixel block includes pixels that output signals corresponding to a plurality of different colors, and the memory unit stores image signals that remains after periodically thinning out image signals of pixels of at least one color of the plurality of different colors from image signals acquired by the first image capturing operation.

7. The system according to claim 1, wherein the memory unit stores a signal for a predetermined number of bits of an image signal acquired by the first image capturing operation, and does not store a signal for a lower bit than the predetermined number of bits.

8. The system according to claim 1, wherein the memory unit stores a difference value between image signals, among image signals acquired by the first image capturing operation, of pixels of the same color arranged adjacent to each other in the same row among the plurality of pixels arranged in the matrix.

9. The system according to claim 1, further comprising a signal generation unit configured to generate a third image signal corresponding to the one frame period from a second image signal acquired by the second image capturing operation in a case where it is determined that there is no flicker based on determination as to whether flicker has occurred.

10. A photoelectric conversion apparatus comprising an image sensor arranged with a plurality of pixel blocks in which a plurality of pixels are arranged in a matrix,
wherein
in one frame period, the apparatus performs a first image capturing operation that includes an exposure period based on a first exposure condition set in advance, and a second image capturing operation for which an exposure period is controlled based on a second exposure condition decided for each pixel block, and outputs image signals based on the first image capturing operation and the second image capturing operation, and
a data amount of an image signal based on the first image capturing operation output by the apparatus is smaller than a data amount of the image signal based on the second image capturing operation output by the apparatus.

11. A photoelectric conversion system comprising a photoelectric conversion apparatus defined in claim 10, and a memory unit configured to store an image signal based on the first image capturing operation output from the photoelectric conversion apparatus,
wherein the memory unit stores an image signal based on the first image capturing operation until an image signal based on the second image capturing operation is output from the photoelectric conversion apparatus.

12. A photoelectric conversion system comprising a photoelectric conversion apparatus defined in claim 10, and an image processing apparatus configured to process an image signal output from the photoelectric conversion apparatus,
wherein the image processing apparatus generates an image signal corresponding to the one frame period based on an image signal based on the first image capturing operation and an image signal based on the second image capturing operation, which are output from the photoelectric conversion apparatus.

13. A photoelectric conversion system comprising a photoelectric conversion apparatus defined in claim 10, and an image processing apparatus configured to process an image signal output from the photoelectric conversion apparatus,
wherein the image processing apparatus determines whether flicker has occurred and, in a case where it is determined that there is no flicker, generates an image signal corresponding to the one frame period from an image signal based on the second image capturing operation.

14. A photoelectric conversion apparatus comprising an image sensor arranged with a plurality of pixel blocks in which a plurality of pixels are arranged in a matrix,
wherein
in one frame period, the apparatus performs a first image capturing operation that includes an exposure period based on a first exposure condition set in advance, and a second image capturing operation for which an exposure period is controlled based on a second exposure condition decided for each pixel block, and the apparatus outputs, as an image signal based on the first image capturing operation, an image signal having a data amount smaller than a data amount of an image signal acquired by the first image capturing operation.

15. A photoelectric conversion system comprising a photoelectric conversion apparatus defined in claim 14, and a memory unit configured to store an image signal based on the first image capturing operation output from the photoelectric conversion apparatus,
wherein the memory unit stores an image signal based on the first image capturing operation until an image signal based on the second image capturing operation is output from the photoelectric conversion apparatus.

16. A photoelectric conversion system comprising a photoelectric conversion apparatus defined in claim 14, and an image processing apparatus configured to process an image signal output from the photoelectric conversion apparatus,
wherein the image processing apparatus generates an image signal corresponding to the one frame period based on an image signal based on the first image capturing operation and an image signal based on the second image capturing operation, which are output from the photoelectric conversion apparatus.

17. A photoelectric conversion system comprising a photoelectric conversion apparatus defined in claim 14, and an image processing apparatus configured to process an image signal output from the photoelectric conversion apparatus,
wherein the image processing apparatus determines whether flicker has occurred and, in a case where it is determined that there is no flicker, generates an image signal corresponding to the one frame period from an image signal based on the second image capturing operation.

18. Equipment comprising:
a photoelectric conversion system defined in claim 1; and
a processing apparatus configured to process a signal output from the photoelectric conversion system.

19. Equipment comprising:
a photoelectric conversion system defined in claim 11; and
a processing apparatus configured to process a signal output from the photoelectric conversion system.

20. Equipment comprising:
a photoelectric conversion system defined in claim 15; and
a processing apparatus configured to process a signal output from the photoelectric conversion system.
